(19) United States
(12) Patent Application Publication
(10) Pub. No.: US 2008/0285399 A1
(43) Pub. Date: Nov. 20, 2008

(54) Recorder, Player, and Recorder/Player

(76) Inventor: Yoshiharu Kobayashi, Osaka (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 11/577,413

(22) PCT Filed: Oct. 20, 2005
(86) PCT No.: PCT/JP2005/019310

§ 371 Date: Apr. 18, 2007

(30) Foreign Application Priority Data
Oct. 20, 2004 (JP) 2004-305456

(51) Int. Cl. G11B 7/00

(52) U.S. Cl. 369/44.32

(57) ABSTRACT

An apparatus according to the present invention includes a write compensation section, which generates a write signal to write information on an information storage medium, and a writing section for irradiating the information storage medium with a pulsed beam based on the write signal generated by the write compensation section. The information storage medium includes a recording layer, which has an optical constant that changes continuously with the total quantity of light received. The writing section radiates and condenses multiple pulsed beams on the recording layer at an interval that is shorter than the diameter of the pulsed beams on the recording layer. The write compensation section generates the write signal such that the each sum of variations in the optical constant at each irradiated spot of the pulsed beam on the recording layer through the end of a write operation forms a predetermined variation pattern.

### TECHNICAL FIELD

The present invention relates to an apparatus for reading and/or writing information from/on an information storage medium.

### BACKGROUND ART

To increase the storage capacity of an optical disk medium, which is one of various types of information storage media, it is effective to increase the numerical aperture of the objective lens and shorten the wavelength of the laser beam. This is because the size of a condensed laser beam spot is inversely proportional to the numerical aperture of an objective lens and directly proportional to the wavelength of the laser beam. That is why if the numerical aperture of the objective lens is increased and if the wavelength of the laser beam is shortened, the size of the condensed laser beam spot can be decreased and read/write operations can be done with marks and spaces of reduced lengths. Such a method of writing information with the mark/space widths varied is called a pulse width modulation (PWM) recording.

Hereinafter, conventional methods for reading/writing information from/on an optical disk medium will be described with reference to the accompanying drawings.

FIG. 1 shows a conventional method of writing to an optical disk medium. The optical disk medium 11, which is any conventional optical disk medium, includes either concentric or spiral tracks 12 as shown in the enlarged view 16 of an area A 15. Supposing the shaded track 12 in FIG. 1 is a target track of a write operation, the optical disk medium 11 is spinning such that the write beam spot 14 moves along that track 12. The write operation is performed by changing the light intensities of the write beam spot 14 with a write signal. In FIG. 1, the write beam spot 14 is illustrated as moving on the stilled optical disk medium 11 for the sake of simplicity. However, this situation is substantially the same as a situation where the write beam spot 14 is stopped and the optical disk medium 11 is moving. In the following description, the beam spot is supposed to move on a fixed optical disk medium for the sake of simplicity.

Such a method of writing using a beam spot works like a sort of low pass filtering because the condensed spot has a finite size. That is to say, the higher the frequency of the recording signal (i.e., the smaller the marks or spaces to be record), the more difficult it is to get the write operation done accurately. That is why in a conventional optical disk medium, to increase the recording density, the write data is converted into a run-length limited code, thereby making the lengths of the marks and spaces to be record greater than one bit and trying to get the write operation done using a write signal with as low frequency as possible. Such a code adapted to write properties is called a “recording code”.

FIG. 2 shows the procedure of data conversion when data is written on a conventional optical disk medium. In portions (a) through (d) of FIG. 2, the abscissa represents the location on the track. The locations on the track are aligned with each track. The binary data shown in portion (a) of FIG. 2 represents the data to be written. To decrease the frequency of the write signal, the binary data shown in portion (a) of FIG. 2 is converted into the recording code shown in portion (b) of FIG. 2, i.e., the run-length limited code, as described above. In this example, two bits of the binary data are converted into three bits of the recording code and the minimum run length is supposed to be two. If the length of one bit of the binary data is B, the minimum run length of the recording code is 1.33 B, thus decreasing the recording frequency compared to the recording frequency where data is stored as the binary data.

In converting the recording code shown in portion (b) of FIG. 2 into that shown in portion (c) of FIG. 2, write compensation is made. For example, in a thermal recording operation such as phase change recording, if the data represented by the recording code is stored as it is as the intensity of the write beam without making write compensation, then marks or spaces that are either larger or smaller than those of the recording code will be record on the track due to the propagation of the heat. Or if the heat is accumulated, then the marks will have an increased width. To avoid those phenomena, the width of the write signal may be increased or decreased with the expected increase or decrease of the marks or spaces lengths taken into account in advance. Alternatively, to avoid the accumulation of the heat, the write signal may have a rectangular waveshape with a decreased duty. Such processing of generating a write signal based on a recording code to perform a write operation as accurately as possible is called “write compensation”. Especially as the recording density required goes higher and higher, it becomes increasingly necessary to get the write operation done as accurately as possible. That is why the write compensation is a must as far as high-density writing is concerned.

By controlling the light intensity of the write beam spot with the write-compensated write signal and moving such a write beam spot, data is written on the track. Considering a single location on the track of the recording layer, that single location is irradiated with pulsed beams a number of times. The temperature at that location rises every time the location is irradiated with the pulsed beam. And if the sum of the temperature increases exceeds the threshold value of the phase change material, the reflectance changes at that location. Otherwise, the reflectance does not change. That is to say, the reflectance at that location has one of two values depending on whether the sum of the temperature increases has exceeded the threshold value or not.

The pattern shown in portion (d) of FIG. 2 shows the distribution of reflectances on the track of the optical disk medium in a situation where data has been written on the phase change recording layer with the write signal shown in portion (c) of FIG. 2, i.e., the distribution of reflectances on the track that was subjected to the PWM recording. In this case, by being irradiated with the write beam, crystalline portions of the phase change recording layer turn into amorphous portions and the reflectance changes there. That is why there are just two reflectances.

FIG. 3 shows how to read the data that was written as shown in FIG. 2. The pattern shown in portion (a) of FIG. 3 is the same as that shown in portion (d) of FIG. 2 and shows the reflectance pattern of the track that was subjected to the PWM recording. By scanning this track with a read beam spot 31 and detecting the reflected light, the read signal shown in portion (b) of FIG. 3 is obtained.

As described above, the read signal has had its high frequency components attenuated. That is why after its high frequency components have been amplified with a cosine equalizer, for example, its signal levels are determined to be zero or one, i.e., digitized. The digitization is realized by setting a predetermined slice level or by performing most likelihood decoding by PRML, for example. A PLL circuit for comparing the phases of a VCO with respect to the edges of the digitized signal generates a read clock signal. And by sampling the digitized signal with the read clock signal generated, the read digitized data shown in portion (c) of FIG. 3 can be obtained.

The read digitized data is converted inversely to that of the write operation, i.e., the recording code is converted into binary data, thereby obtaining the read binary data shown in portion (d) of FIG. 3.

Meanwhile, a method for increasing the recording density differently from the approach adopted in the conventional optical disk medium described above, i.e., the PWM method in which zeros and ones of digital data are recorded as marks and spaces, has also been proposed. An analog recording method has also been suggested. For example, according to Patent Document No. 1, a master for an optical disk medium is made by cutting track grooves as the modulated recording data, and the track groove shapes of the optical disk medium, transferred from the master, are recognized, thereby reading and writing data.

FIG. 4A illustrates the shapes of track grooves with modulated widths on the optical disk medium disclosed in Patent Document No. 1. The track grooves 42 have their track widths changed symmetrically with respect to the centerline 43 of the tracks. A master having such track grooves 42 can be obtained by cutting the base material with a cutting beam, of which the intensity is modulated with a write signal obtained from recording data. A stamper is made from that master and used to make the optical disk medium 41 by a pressing process. If the centerline 43 of the tracks on the optical disk medium 41 is scanned with a read beam spot 31, the first-order diffracted light of a reflected portion of the read beam spot 31 has its intensity changed with the widths of the track grooves. As a result, the intensity of the totally reflected light also changes and the widths of the track grooves can be detected by the amplitude of the reflected light detection signal according to Patent Document No. 1.

FIG. 4B illustrates an optical disk medium 44 of which the track grooves are modulated so as to be shifted radially as also disclosed in Patent Document No. 1. The track grooves 45 are just shifted radially with respect to the centerline 43 of the tracks without changing their width. A master having such track grooves 45 can be obtained by cutting the base material with a cutting beam, of which the beam spot is shifted radially with respect to the centerline of the tracks. A stamper is made from that master and used to make the optical disk medium 44 by a pressing process. The centerline 43 of the tracks on the optical disk medium 44 is scanned with a read beam spot 31, and the reflected light is detected by a photodetector, of which the photosensitive area has been divided into two in the radial direction. As the track grooves 45 shift radially, the differential signal of the detector that has had its photosensitive area divided into two (i.e., a differential tracking signal of a push-pull tracking type) changes. Consequently, the radial shift of the track grooves can be detected with the differential signal according to Patent Document No. 1.

Another example, different from the simple PWM recording, is disclosed in Patent Document No. 2, which teaches a method of writing a signal by orthogonal frequency division multiplexing with the PWM and pulse amplitude modulation (PAM) methods combined. FIG. 5A shows an exemplary application of the PAM method to an optical disk medium. As shown in the upper portion of FIG. 5A, the write beam of an optical disk medium usually has a Gaussian illumination distribution. In a normal optical disk medium that performs thermal recording as in a magneto-optical disk or a phase change disk, if a write operation is carried out at regular intervals using an impulse write beam as shown in the upper portion of FIG. 5A and with the impulse height increased, the pits to be record on the optical disk medium increase their sizes as the impulse height becomes higher as shown in the middle portion of FIG. 5A. The sizes of the pits increase in not just the tracking direction but also the radial direction. And if the pit pattern shown in the middle portion of FIG. 5A is irradiated with a read beam with a constant intensity, a stepped read signal such as that shown in the lower portion of FIG. 5A can be obtained. As a result, the intensity of the read signal becomes a function of the impulse height of the write signal, thus realizing the PAM method.

FIG. 5B is an example in which the PWM and PAM methods disclosed in Patent Document No. 2 are applied to an optical disk medium. The upper portion of FIG. 5B shows the shapes of pits that are left when a write operation is performed using the PWM and PAM methods in combination. When such a sequence of pits is read by being irradiated with a read beam, a read signal compliant with the orthogonal frequency division multiplexing is generated as shown in the middle portion of FIG. 5B. The pits in the upper portion of FIG. 5B are left so as to represent a write signal, which is divided into multiple intervals, each having a time unit length T as shown in the lower portion of FIG. 5B. A single time unit length T is further divided into a number n1×2 sections. By controlling the width w of the center portion and the height a of the end portions with a symmetrical square wave with a length of 2 w located at the center of the time unit length and interposed between signals with a width of 1/nl and the height a, the pits in the upper portion of FIG. 5B are formed.
Patent Document No. 1: Japanese Patent Application Laid-Open Publication No. 11-316951
Patent Document No. 2: United States Patent application Publication Ser. No. 2004/0125732

### DISCLOSURE OF INVENTION

### Problems to be Solved by the Invention

These recording methods, however, have the following problems.

Specifically, according to the conventional methods for optical disk media, the technique of increasing the storage capacity, represented by the recording density in the PWM recording, by decreasing the spot size of a laser beam is about to reach the limit. As for BDs (Blu-ray discs), for example, the laser beam should have a wavelength of 405 nm and the objective lens should have a numerical aperture of 0.85. In order to further shorten the laser wavelength to increase the storage capacity, an ultraviolet laser beam will be needed but nobody knows when such a laser beam is available for use in actual products. Also, if the numerical aperture were set greater than 0.85, then a lens with such an NA would not only be hard to make perfectly but also have to be attached with much stricter accuracy. Furthermore, if the numerical aperture exceeded one, then a near-field recording should be performed using an immersion lens, not an ordinary lens. Each of these requirements is very hard to realize. That is why the technique of increasing the recording density by decreasing the laser beam spot has almost reached its limit.

Also, the efficiency of converting binary data to be written into a run-length limited code is 2:3 according to the RLL (1, 7) code for use in BDs and 8:16 according to the 8/16 code for use in DVDs. These conversion efficiencies are not so good, which is one of the reasons for the insufficient increase in recording density. The data shown in portions (a) and (b) of FIG. 2 is converted at a conversion ratio of 2:3 with a minimum run length of 2, which is an example of the RLL (1, 7) code for use in BDs.

Furthermore, the read digitized data may have errors. It is known that if the data shown in portion (c) of FIG. 3 and being converted into the data shown in portion (d) of FIG. 3 (i.e., the digitized data being converted into the binary data inversely to the conversion during the write operation) has errors, then the resultant binary data will have an increased number of errors to deteriorate the error rate. Such a phenomenon is called “error propagation”.

Next, according to the method of Patent Document No. 1, either the width or the radial location of a track groove is changed with a signal, obtained by modulating the amplitude of write data, thereby recording write data on a master. That is to say, the master of an optical disk medium is made by cutting the track grooves with the modulated signal and the optical disk medium is formed with a stamper made of the master. However, such cutting should be done too accurately to be performed by an optical disk drive. For example, to eliminate external vibrations, the drive itself should be insulated dynamically from the outside world with a servo bench, for example. Besides, as the tracking needs to be subjected to open control, an accurate head feeding mechanism is required. What is more, the degree of planarity of the optical disk medium used and the accuracy of mounting it on the motor should also be sufficiently high. For these reasons, an optical disk drive that can perform read/write operations cannot do such cutting.

Furthermore, the radial shift of a track groove is very small in a normal optical disk system because the shift affects the tracking control. That is why the signal amplitude cannot be so large as to realize a high SNR, and not so much information can be stored. In the wobbled groove of a DVD-RAM, the track groove is also shifted radially as in the method of Patent Document No. 1. In DVD-RAMS, the grooves are shifted radially with respect to the centerline of the tracks. According to chapter 19.5 of the ECMA-33 standard, the magnitude of a wobble signal representing this groove shift is defined to be 5% to 10% of that of a tracking differential signal. This signal amplitude is very small.

Also, if the width of a track groove were changed, then the tracking signal itself would be modulated and the tracking control should be affected. That is why the track groove width cannot be changed significantly. As a result, the signal amplitude cannot be so large as to realize a high SNR, and not so much information can be stored.

According to the method of Patent Document No. 2, a single time unit length T is further divided into n1×2 sections as shown in FIG. 5B, and therefore, a PWM recording accuracy needs to be at least equal to T/(n1×2). This is because the length T/(n1×2)(which will be referred to herein as “division length”) needs to be equal to one bit length of the recording code of the PWM recording.

For example, suppose data for four sub-channels (i.e., 16 bits) needs to be written in a single symbol by 16 QAM modulation. The waveform of 16 QAM needs to have 16 levels in the amplitude direction. Also, supposing there are four sub-channels, the amplitude could be increased fourfold at most, recording will be performed in 64 gray scales (=16 gray scales×4), and n1=64. Therefore, the time unit length T is divided into 66 (=64+2) sections, where the last two bits added correspond to the data with the height a at both ends of the time unit length. Since one division length corresponds to one bit of the PWM recording code, one time unit length T will be 66 bits×74.5 nm=4917 nm supposing that recording can be done as accurately as on a BD. This length is much greater than the beam spot size of approximately 582 nm in a BD system. One time unit length T is preferably approximately several times as large as the beam spot size. If one time unit length T needs to be twice as large as the beam spot size, the one time unit length T should be approximately equal to 582 nm×2/4917 nm≈1/4.2. Thus, one division length (T/(n1×2)) should be 74.5 nm/4.2=17.7 nm, at which recording cannot be done. If the number of gray scales is decreased to a fourth, then the division length will be approximately equal to one bit length on the recording code of a BD. However, the number of sub-channels will be one and only four bits can be written per time unit length T, which is no different from the recording density of a BD.

Consequently, according to the writing method of Patent Document No. 2, the recording density realized will be at most equal to, or even lower than, that achieved by the PWM method.

In order to overcome the problems described above, an object of the present invention is to increase the recording density of an information storage medium.

### Means for Solving the Problems

An apparatus according to the present invention includes a write compensation section, which generates a write signal to write information on an information storage medium, and a writing section for irradiating the information storage medium with a pulsed beam based on the write signal generated by the write compensation section. The information storage medium includes a recording layer, which has an optical constant that changes continuously with the total quantity of light received. The writing section radiates and condenses multiple pulsed beams on the recording layer at an interval that is shorter than the diameter of the pulsed beams on the recording layer. The write compensation section generates the write signal such that the each sum of variations in the optical constant at each irradiated spot of the pulsed beam on the recording layer through the end of a write operation forms a predetermined variation pattern.

In one preferred embodiment, the optical constant is a refractive index.

In this particular preferred embodiment, the refractive index varies in response to a two-photon absorption reaction of the material of the recording layer, and the probability of the two-photon absorption reaction is proportional to the square of the intensity of the pulsed beam.

In an alternative preferred embodiment, the refractive index varies as the molecules of the recording layer change their directions perpendicularly to the plane of polarization of the pulsed beam, and the probability of change of the directions of the molecules is proportional to the square of the intensity of the pulsed beam.

In another alternative preferred embodiment, the refractive index varies in response to a one-photon absorption reaction of the material of the recording layer, and the probability of the one-photon absorption reaction is proportional to the intensity of the pulsed beam.

In another alternative preferred embodiment, the refractive index varies as the molecules of the recording layer change their directions perpendicularly to the plane of polarization of the pulsed beam, and the probability of change of the directions of the molecules is proportional to the intensity of the pulsed beam.

In a specific preferred embodiment, the material is diarylethene.

In another specific preferred embodiment, the recording layer includes photoaddressable polymers (PAPs).

In still another preferred embodiment, the apparatus further includes a modulating section for generating a signal representing the information by combining a plurality of sub-channel signals with each other. The information is written on the basis of a symbol with a predetermined length. A difference in frequency between carrier signals of the sub-channel signals is an integral multiple of the product of the spatial frequency of the symbol and a relative velocity of a beam spot with respect to the information storage medium.

In this particular preferred embodiment, the sub-channel signals have been subjected to phase modulation and the number of phase divisions is defined for each said sub-channel.

In an alternative preferred embodiment, the sub-channel signals have been subjected to orthogonal amplitude modulation and a signal point is set for each said sub-channel.

In another alternative preferred embodiment, the write compensation section generates the write signal such that there is a non-recorded area with a predetermined length between the symbols.

In a specific preferred embodiment, the write compensation section generates the write signal such that the non-recorded area is located between areas irradiated with a pulsed beam with prescribed power.

In yet another preferred embodiment, the information storage medium includes a plurality of recording layers including the recording layer.

Another apparatus according to the present invention is designed to generate a write signal to write information on an optical disk medium in the cast of use in an optical disk drive for writing data on the optical disk medium. The optical disk drive includes a writing section for irradiating the optical disk medium with a pulsed beam based on the write signal. The optical disk medium includes a recording layer, which has an optical constant that changes continuously with the total quantity of light received. The writing section radiates and condenses multiple pulsed beams on the recording layer at an interval that is shorter than the diameter of the pulsed beams on the recording layer. And the apparatus generates the write signal such that the each sum of variations in the optical constant at each irradiated spot of the pulsed beam on the recording layer through the end of a write operation forms a predetermined variation pattern.

A writing method according to the present invention includes the steps of: generating a modulation signal to write encoded information on an information storage medium; and irradiating the information storage medium with a pulsed beam based on the write signal generated by a write compensation section. The information storage medium includes a recording layer, which has an optical constant that changes continuously with the total quantity of light received. The step of irradiating includes radiating and condensing multiple pulsed beams on the recording layer at an interval that is shorter than the diameter of the pulsed beams on the recording layer. The step of generating the write signal includes generating the write signal such that the each sum of variations in the optical constant at each irradiated spot of the pulsed beam on the recording layer through the end of a write operation forms a predetermined variation pattern.

A program according to the present invention is set up to make an apparatus for writing data on an information storage medium perform recording processing. The recording processing includes the steps of: generating a modulation signal to write information on the information storage medium; and irradiating the information storage medium with a pulsed beam based on the write signal generated by a write compensation section. The information storage medium includes a recording layer, which has an optical constant that changes continuously with the total quantity of light received. The step of irradiating includes radiating and condensing multiple pulsed beams on the recording layer at an interval that is shorter than the diameter of the pulsed beams on the recording layer. The step of generating the write signal includes generating the write signal such that the each sum of variations in the optical constant at each irradiated spot of the pulsed beam on the recording layer through the end of the recording processing forms a predetermined variation pattern.

Still another apparatus according to the present invention is designed to read information from an information storage medium. The information storage medium includes a recording layer, which has an optical constant that changes continuously with the total quantity of light received. The information has been stored on the recording layer as a combination of a plurality of sub-channel signals. The apparatus includes: a reading section, which irradiates the recording layer with a beam to generate a read signal based on the light that has been reflected from the information storage medium; and a demodulating section, which multiplies the read signal and each of carrier signals together to generate each of sub-channel signals, associated with the respective carrier signal, and detect the information based on each sub-channel signal.

In one preferred embodiment, the information has been stored on the recording layer on the basis of a symbol with a predetermined length. There is a non-recorded area that stores no information between the symbols of the recording layer. And the demodulating section detects the top of the symbol by reference to a signal indicating the non-recorded area in the read signal.

In this particular preferred embodiment, the demodulating section generates a clock signal based on the signal indicating the non-recorded area.

In an alternative preferred embodiment, the non-recorded area is interposed between areas with a predetermined optical constant pattern.

An information storage medium according to the present invention includes a base material and a recording layer for storing information. The information is stored in the recording layer on the basis of a symbol with a predetermined length. And there is a non-recorded area that stores no information between the symbols of the recording layer.

In one preferred embodiment, the recording layer has an optical constant that changes continuously with the total quantity of light received, and the non-recorded area is interposed between areas with a predetermined optical constant pattern.

### EFFECTS OF THE INVENTION

Paying attention to one particular location on an information storage medium, the information storage medium of the present invention includes a recording layer, which has an optical constant that changes continuously with the integrated quantity of light received at that location. When the recording layer is irradiated with multiple pulsed beams at an interval that is shorter than the diameter of the pulsed beams, a write compensation section generates a write signal such that the sum of variations in the optical constant at each irradiated spot of the pulsed beam on the recording layer through the end of a write operation has a predetermined variation pattern. By using such an information storage medium that has a continuously changing optical constant, information can be written using a multiplexed signal (e.g., an orthogonal frequency division multiplexed signal) and the recording density of the information storage medium can be increased. Also, by generating the write signal such that the sum of variations in the optical constant has a predetermined variation pattern, information can be written on such an information storage medium that has a continuously changing optical constant.

According to the present invention, a non-run-length-limited code can be used. That is why the error rate never deteriorates due to propagation of errors of a recording code and the errors can also be corrected. As a result, the recording density can be further increased.

In a preferred embodiment of the present invention, a difference in frequency between carrier signals of respective sub-channel signals is an integral multiple of the product of the inverse number of one symbol length and the linear velocity of the optical disk medium. Thus, the respective sub-channel signals have an orthogonal relation with respect to each other. By superposing those sub-channel signals with each other, a write signal is generated. And following the pattern of such a write signal, the optical constant of the recording layer changes and a write operation is carried out on a symbol-by-symbol basis. That is to say, this write operation is performed without threshold values, i.e., as analog recording.

In another preferred embodiment of the present invention, information is written on an information storage medium by superposing a number of mutually orthogonal sub-channel signals on a symbol-by-symbol basis. Also, a read signal is generated based on the light that has been reflected from such an information storage medium, and is multiplied by each of carrier signals, thereby generating each of sub-channel signal. Then, the stored information is detected using those sub-channel signals. By reading and writing information by a multiplexing method such as orthogonal frequency division multiplexing in this manner, the recording density of the information storage medium can be increased.

In still another preferred embodiment of the present invention, when irradiated with a beam, the molecules of the material of the recording layer change their directions perpendicularly (or parallel) to the plane of polarization of the beam, thereby writing information there. When the molecules of the material of the recording layer change their directions, an optical rotatory phenomenon arises, thus changing the refractive index. And when the refractive index changes, the reflectance also changes. Also, the directions of the molecules of the material of the recording layer are proportional to the square of the beam intensity. Furthermore, as there are two optical rotatory directions, two different pieces of information can be written per sub-channel.

In yet another preferred embodiment of the present invention, the optical constant (such as refractive index) changes due to the two-photon absorption reaction of the material of the recording layer. Therefore, the optical constant is proportional to the square of the intensity of the pulsed beam. That is why even if the recording power has varied for some reason, the influence on the optical constant is proportional to the root of the power variation. That is to say, the influence of the power variation on the optical constant can be reduced. As a result, the recording power margin can be increased and more stabilized recording is realized.

### BRIEF DESCRIPTION OF DRAWINGS

FIG. 1 shows a conventional method of writing to an optical disk medium.

FIG. 2 shows a conventional method of writing to an optical disk medium.

FIG. 3 shows a conventional method of reading from an optical disk medium.

FIG. 4A shows a conventional method of writing to an optical disk medium.

FIG. 4B shows a conventional method of writing to an optical disk medium.

FIG. 5A shows a conventional method of writing to an optical disk medium.

FIG. 5B shows a conventional method of writing to an optical disk medium.

FIG. 6 shows a format for an information storage medium according to a preferred embodiment of the present invention.

FIG. 7 shows a recorder/player according to a preferred embodiment of the present invention.

FIG. 8 shows a writing method according to a preferred embodiment of the present invention.

FIG. 9 shows how to radiate a write beam according to the writing method of the preferred embodiment of the present invention.

FIG. 10A shows a beam intensity distribution according to the writing method of the preferred embodiment of the present invention.

FIG. 10B shows a refractive index distribution according to the writing method of the preferred embodiment of the present invention.

FIG. 11A shows another beam intensity distribution according to the writing method of the preferred embodiment of the present invention.

FIG. 11B shows another refractive index distribution according to the writing method of the preferred embodiment of the present invention.

FIG. 12 shows how much the non-linearity of the writing method according to a preferred embodiment of the present invention needs to be compensated for.

FIG. 13 shows parameters for one symbol as for a read operation according to a preferred embodiment of the present invention.

FIG. 14 shows the operation of scanning a single symbol with a read beam to generate a read signal according to a preferred embodiment of the present invention.

FIG. 15 shows a matrix equation defining the relation between the read beam, reflectance distribution and read signal for a single symbol according to a preferred embodiment of the present invention.

FIG. 16A shows parameters for recording a symbol according to a preferred embodiment of the present invention.

FIG. 16B shows write beams for recording a symbol according to a preferred embodiment of the present invention.

FIG. 17 shows a matrix equation representing the beam power distribution of one pulse of the write beam within a single symbol according to a preferred embodiment of the present invention.

FIG. 18A shows a matrix equation for calculating a refractive index distribution after a k^{th} write beam has been radiated according to a preferred embodiment of the present invention.

FIG. 18B shows a matrix equation for calculating a refractive index distribution after the k^{th} write beam has been radiated according to a preferred embodiment of the present invention.

FIG. 19 shows a matrix equation representing the beam intensity after a write beam for one symbol has been radiated according to a preferred embodiment of the present invention.

FIG. 20A shows a turbo code modulator according to a preferred embodiment of the present invention.

FIG. 20B shows components of the turbo code modulator according to the preferred embodiment of the present invention.

FIG. 20C shows the state transition diagram of a ⅚ recursive systematic convolutional modulator according to a preferred embodiment of the present invention.

FIG. 21A shows an orthogonal frequency division modulator according to a preferred embodiment of the present invention.

FIG. 21B shows 64 QAM modulation mapping according to a preferred embodiment of the present invention.

FIG. 21C shows the 64 QAM modulation mapping according to the preferred embodiment of the present invention.

FIG. 22 shows a refractive index pattern calculator according to a preferred embodiment of the present invention.

FIG. 23A shows a write pulse intensity calculator according to a preferred embodiment of the present invention.

FIG. 23B shows an fk calculator for the write pulse intensity calculator according to the preferred embodiment of the present invention.

FIG. 24 shows a reading method according to a preferred embodiment of the present invention.

FIG. 25 shows a read circuit according to a preferred embodiment of the present invention.

FIG. 26 shows an orthogonal frequency division demodulator according to a preferred embodiment of the present invention.

FIG. 27A shows a turbo code demodulator according to a preferred embodiment of the present invention.

FIG. 27B shows a MAP decoder for the turbo code demodulator according to the preferred embodiment of the present invention.

FIG. 28A shows an example of read signal arrangements according to a preferred embodiment of the present invention.

FIG. 28B shows another example of read signal arrangements according to a preferred embodiment of the present invention.

FIG. 29 shows a read synchronizing method according to a preferred embodiment of the present invention.

FIG. 30 shows the storage densities achieved by a writing method according to a preferred embodiment of the present invention and PWM recording, which is a conventional writing method, in comparison.

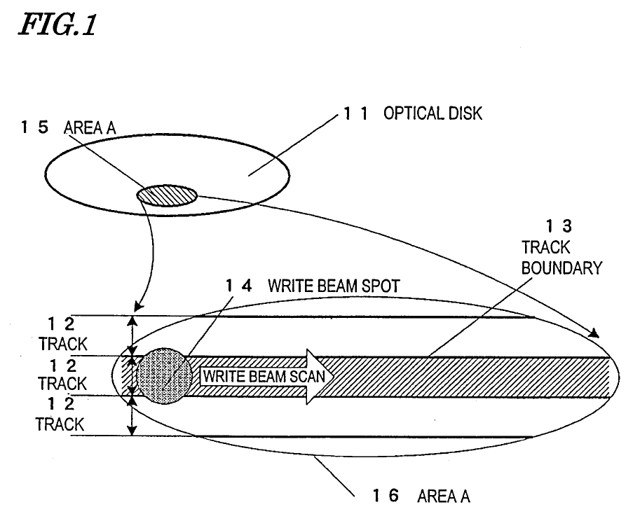

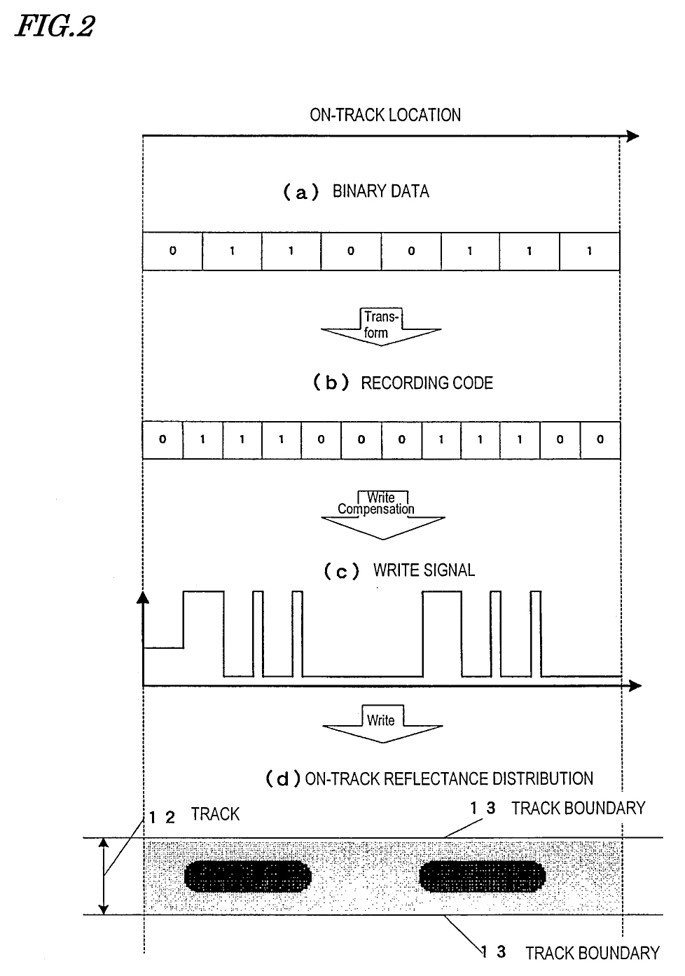

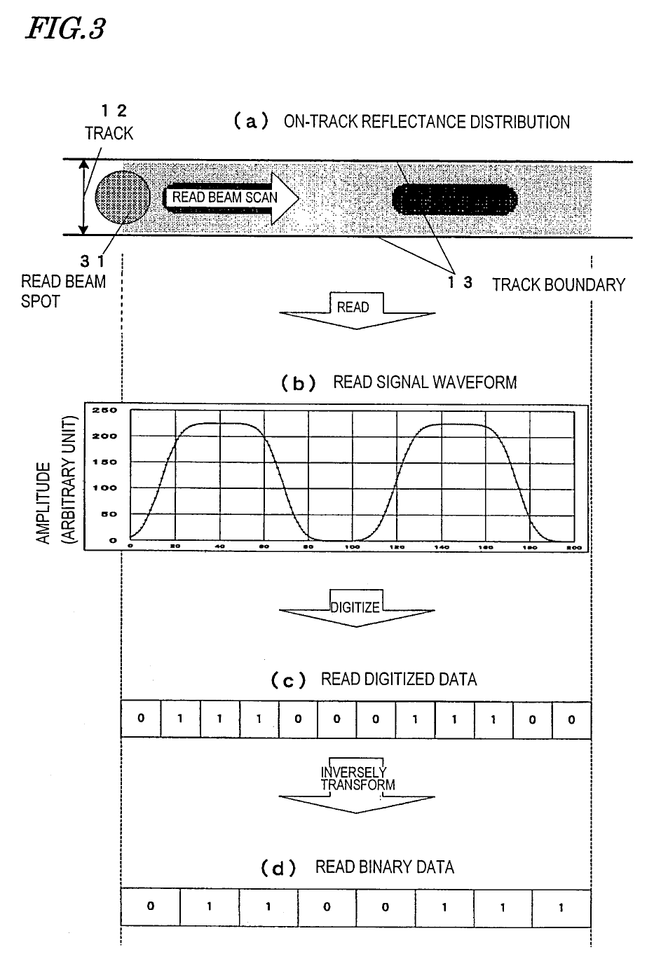

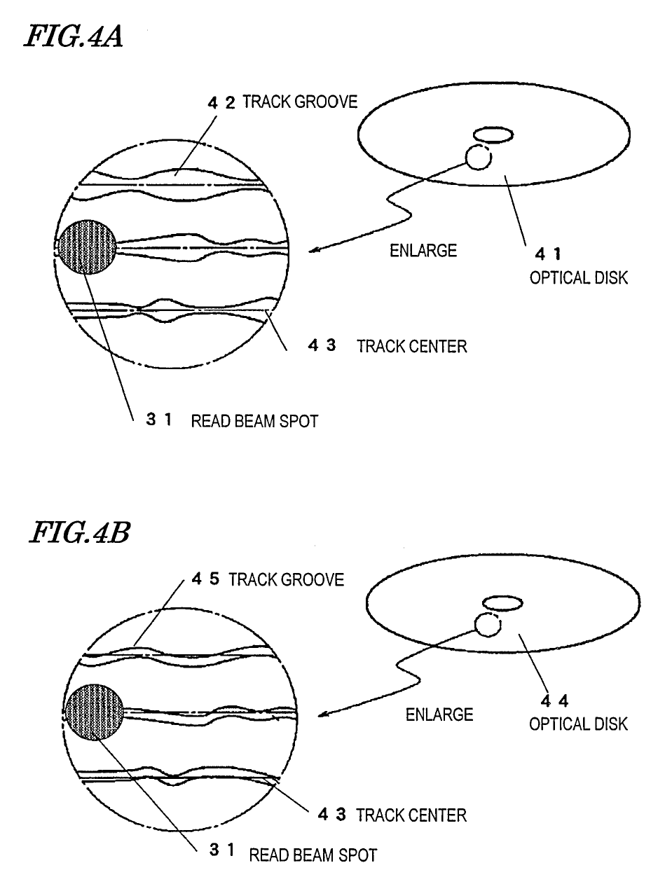

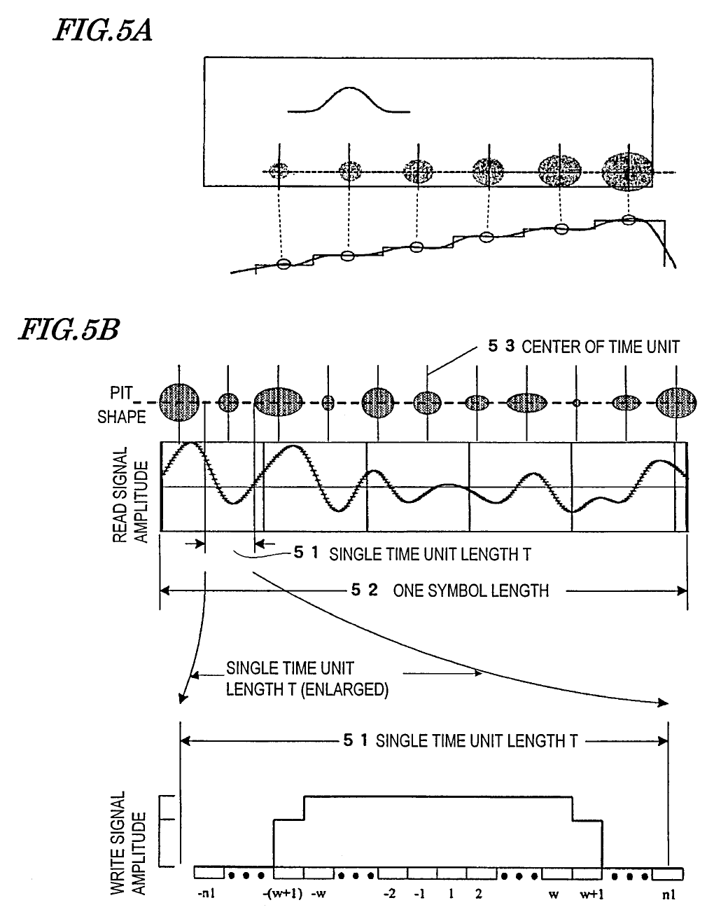

### DESCRIPTION OF REFERENCE NUMERALS

11 optical disk medium
12 track
13 track boundary
14 write beam spot
15 area A
16 enlarged view of area A
31 read beam spot
41 optical disk medium
42 track groove
43 track center
44 optical disk medium
45 track groove
60 information storage medium
61 optical disk medium
62 symbol
63 symbol boundary
64 write beam spot
65 area B
66 objective lens
67 recording layer
71 write beam spot
81 write beam impulse
82 write signal
83 track center
84 emission interval
91 turbo code modulator
92 turbo code modulated signal
93 orthogonal frequency division modulator
94 orthogonal frequency division modulated signal
95 write compensation section
96 refractive index pattern calculator
97 refractive index signal
98 write pulse intensity calculator
99 write signal
110 pulse laser driver
111 pulse laser drive signal
112 pulse laser diode
113 collimator lens
114 beam splitter
115 quarter wave plate
116 objective lens
117 objective lens actuator
118 optical disk
119 recording layer
120 spindle motor
121 condenser lens
122 group of photosensors
123 focus error signal
124 tracking error signal
125 analog read signal
126 servo circuit
127 actuator drive signal
128 read circuit
129 digital read signal
130 top-of-symbol detection signal
131 orthogonal frequency division demodulator
132 orthogonal frequency division demodulated signal
133 turbo code demodulator
141 write signal
142 read signal
143 last write beam impulse of former symbol
144 last write beam impulse of latter symbol
145 valley of connecting portion of read signal
146 former symbol
147 latter symbol
148 connecting portion
221 8/5 bit converter
222 ⅚ recursive systematic convolutional code modulator
223 random interleaver
224 ⅚ recursive systematic convolutional code modulator
225 selector
230 sub-channel data distributor
231 adder
232 frequency f1 sub-channel encoder
233 frequency f2 sub-channel encoder
234 frequency f3 sub-channel encoder
235 frequency f4 sub-channel encoder
236 frequency f5 sub-channel encoder
237 frequency f6 sub-channel encoder
238 frequency f7 sub-channel encoder
239 frequency f8 sub-channel encoder
240 frequency f9 sub-channel encoder
241 selector
242 symbol modulated data memory
243 selector
244 floating point sum of products calculator
245 Gaussian beam inverse matrix table
246 arithmetic controller
247 storage address/calculated address generator
251 selector
252 refractive index data memory
253 selector
254 selector
255 write signal data memory
256 selector
257 selector
258 fk calculator
259 register
25A ΔA[k] adder
25B fk memory
25C αk memory
25D LU decomposer
25E adder
25F write compensation fixed signal
25G sequence controller
25H convergence decision circuit
25I orthogonal frequency division modulated signal
25J subtractor
261 analog EQ circuit
262 A/D converter
263 top-of-symbol detector
264 sample clock generator
271 frequency f1 sub-channel decoder
272 frequency f2 sub-channel decoder
273 frequency f3 sub-channel decoder
274 frequency f4 sub-channel decoder
275 frequency f5 sub-channel decoder
276 frequency f6 sub-channel decoder
277 frequency f7 sub-channel decoder
278 frequency f8 sub-channel decoder
279 frequency f9 sub-channel decoder
27A decoded value selector
281 decoder #2
282 variance calculator
283 channel value calculator
284 adder
285 random deinterleaver
286 random deinterleaver
287 decoder #1
288 channel value calculator
289 adder
28A random interleaver
28B selector
28C hard decision circuit
291 multiplier
292 1.0 data table
293 Gaussian beam intensity distribution table
294 adder
295 subtractor
296 multiplier
297 multiplier
298 selector
299 register
29A subtractor
301 Euclidean distance calculator
302 reference read signal generator
303 probability calculator
304 selector
305 γ (m, m′) memory
306 selector
307 register
308 adder
309 selector
30A αS(m) memory X
30B selector
30C αS(m) memory
30D selector
30E register
30F adder
30G selector
30H αS(m) memory X
30I selector
30J αS(m) memory
30K selector
30L multiplier
30M adder
30N register
30O multiplier

### BEST MODE FOR CARRYING OUT THE INVENTION

Hereinafter, preferred embodiments of the present invention will be described with reference to the accompanying drawings.

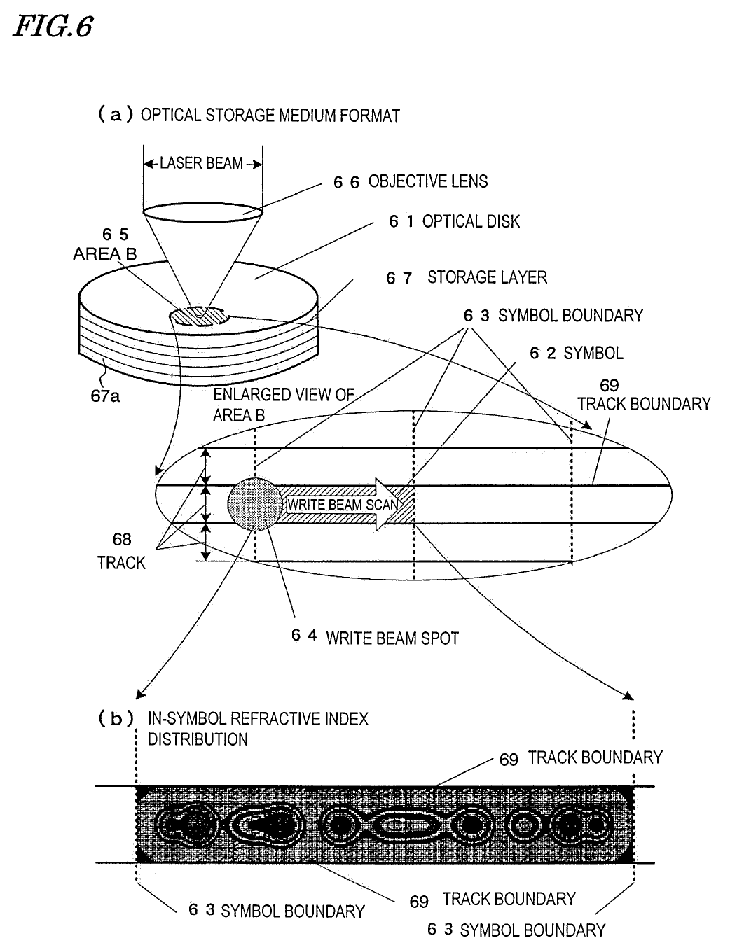

Portion (a) of FIG. 6 shows the format of an information storage medium according to a preferred embodiment of the present invention, which may be an optical disk medium, for example. The optical disk medium 61 shown in portion (a) of FIG. 6 includes a base material 67a and at least one recording layer 67. The recording layer 67 is arranged on the base material 67a. In the example illustrated in FIG. 6, the optical disk medium 61 includes a plurality of recording layers 67.

The recording layer 67 is made of a photon mode recording material with almost no threshold value. Also, the recording layer 67 has an optical constant that changes continuously with the total quantity of light received. For example, the variation in the optical constant of the recording material may be substantially a function (e.g., a liner function or a quadratic function) of the intensity of a write beam. A write operation in which the variation in the optical constant of the recording material is a linear function of the intensity of the write beam is called “one-photon absorption recording”. On the other hand, a write operation in which the variation in the optical constant of the recording material is a quadratic function of the intensity of the write beam is called “two-photon absorption recording”.

The optical constant may be a refractive index, for example. The refractive index changes due to the two-photon or one-photon absorption of the material of the recording layer 67. The probability of the two-photon absorption reaction is proportional to the square of the intensity of the pulsed beam. The probability of the one-photon absorption reaction is proportional to the intensity of the pulsed beam. A recording material with such a property may be diarylethene, for example, and the recording layer 67 includes such a material.

Also, in a preferred embodiment, the refractive index varies as the molecules of the recording layer change their directions perpendicularly to the plane of polarization of the pulsed beam. The probability of change of the directions of the molecules is proportional to either the square of the intensity of the pulsed beam or the intensity of the pulsed beam itself. A recording material with such a property may be a photoaddressable polymer (PAP), for example, and the recording layer 67 includes such a material.

Examples of materials for the recording layer 67 include fulgide, diarylethene, and PAP, which enable both one-photon absorption recording and two-photon absorption recording alike. These materials produce recording by changing their refractive index, which is one of optical constants. Also, it depends on the recording conditions (such as the wavelength of the beam) whether the recording material is proportional to the squared intensity of the pulsed beam or the intensity of the pulsed beam itself. In the following description, a recording material for two-photon recording such as diarylethene is supposed to be used. However, the principle, functions and effects of the present invention remain the same even if one-photon absorption recording is carried out.

The area B 65 on the optical disk medium 61 shows one of the recording layers 67 of the optical disk medium 61 and an enlarged view of the area B shows the details of the area B. As shown in the enlarged view of the area B, the recording layer 67 includes either concentric or spiral tracks 68, each of which is further divided into symbols 62 with a predetermined length. In each of those symbols 62, data is stored as a refractive index variation pattern as shown in portion (b) of FIG. 6. A number of bits are multiplexed together in this pattern. And a read/write operation is carried out on a symbol-by-symbol basis. That is why unless the pattern of the entire symbol is scanned, data cannot be read.

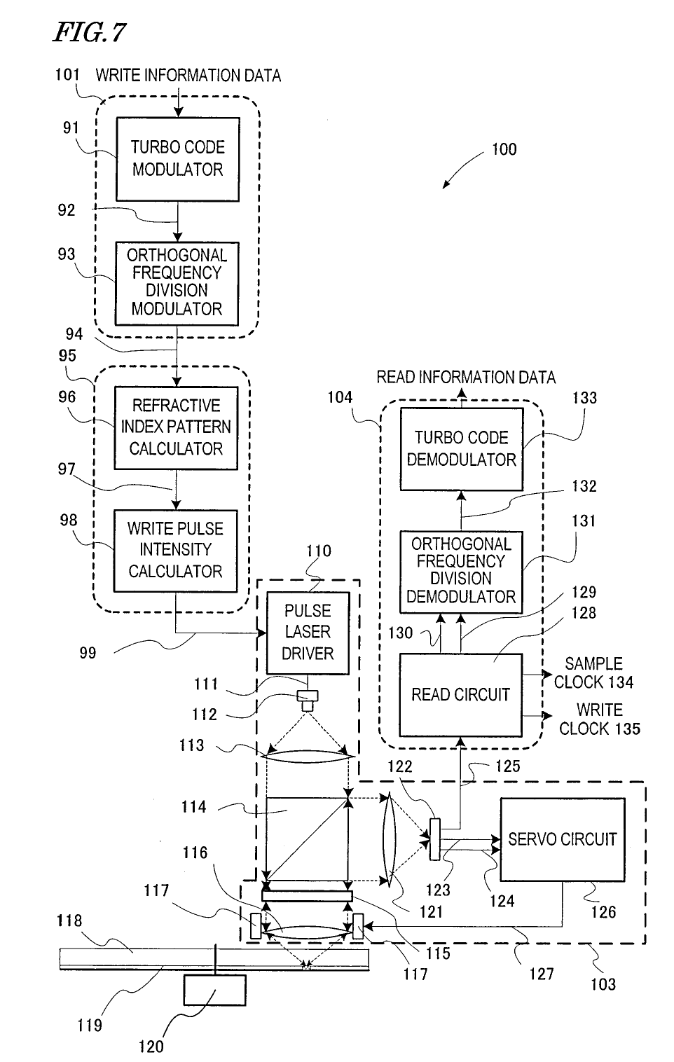

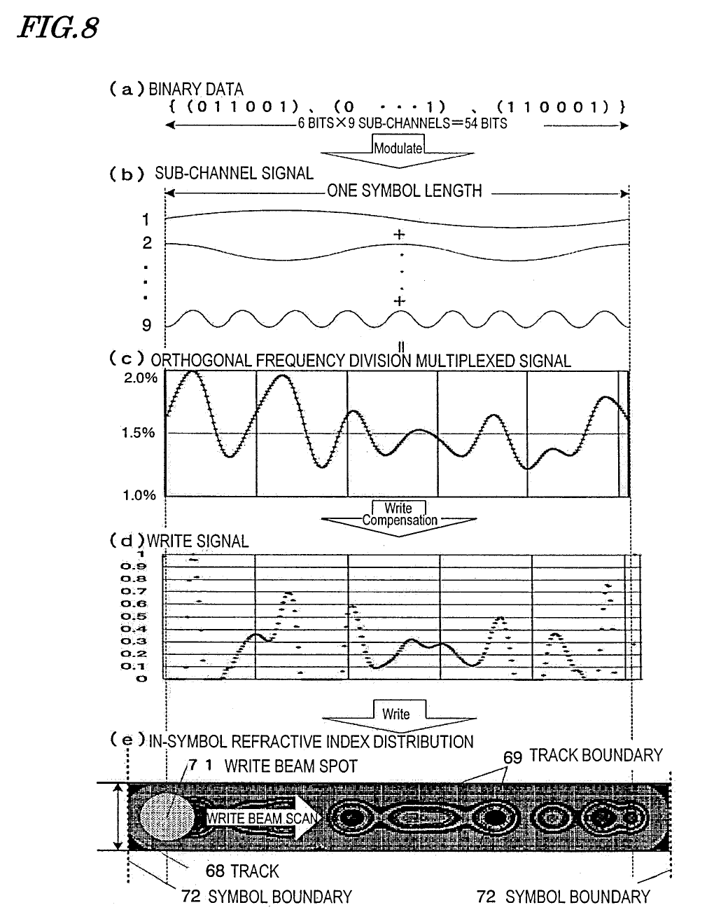

Hereinafter, an optical disk drive 100 for writing data on the optical disk medium 61 of this preferred embodiment and the writing method thereof will be described with reference to FIGS. 7 and 8. FIG. 7 shows the optical disk drive 100.

The optical disk drive 100 includes: a modulating section 101 for generating a multiplexed signal, representing information to be written on the optical disk medium 61, by combining a number of sub-channel signals together; a write compensation section 95 for generating a write signal to write information on the optical disk medium 61; and an optical head section 103 for irradiating the recording layer 67 of the optical disk medium 61 with a converged pulsed beam based on the write signal generated by the write compensation section 95. In writing information on the disk medium 61, the optical head section 103 functions as a recording section. While moving the beam spot of the pulsed beam, the optical head section 103 irradiates the recording layer 67 with a plurality of pulsed beams at intervals that are shorter than the diameter of the pulsed beams on the recording layer 67. The write compensation section 95 generates the write signal such that the sum of variations in the optical constant at each irradiated spot of the pulsed beam on the recording layer 67 through the end of the write operation has a predetermined variation pattern. As used herein, the diameter of the pulsed beams on the recording layer 67 represents the extent of a pulsed beam spot area with a predetermined energy density. For example, the diameter of a pulsed beam may refer to the extent of an area that has generated power I/e² times as high as that at the center of the pulsed beam (where e is a natural logarithm).

Taking a particular location on the recording layer 67, the particular location is irradiated with at least a portion of each of multiple pulsed beams. The write compensating section 95 generates the write signal such that the sum of the variations in the optical constant at the particular location, irradiated with each of the multiple pulsed beams, has a desired value.

The optical disk drive 100 may be either a recorder or a recorder/player. Alternatively, the optical disk drive 100 may also be a player that does not perform a write operation but does perform a read operation (to be described later). Some of those components of the optical disk drive 100 may be fabricated as a semiconductor integrated circuit. For example, the write compensation section 95 may be fabricated as a semiconductor integrated circuit. Those components of the optical disk drive 100 will be described in detail later.

Hereinafter, a writing method according to a preferred embodiment of the present invention will be described with reference to FIG. 8.

The binary data shown in portion (a) of FIG. 8 is data to be written. Portion (e) of FIG. 8 shows a refractive index distribution produced in a symbol on the optical disk medium. As can be seen, the binary data to be written has been recorded as a refractive index pattern. Now it will be described with reference to portions (a) through (e) of FIG. 8 in this order exactly how the binary data is written there.

The data to be written is stored on the basis of a symbol with a predetermined length. For example, the binary data shown in portion (a) of FIG. 8 has been divided into multiple units, each having a predetermined number of bits. And the write operation is carried out on the basis of the binary data including a predetermined number of bits. That is to say, this number of bits is the number of bits to be stored in a single symbol. In portion (a) of FIG. 8, the binary data included in the pair of braces is the data to be written in a single symbol, which has a size of 54 bits in this example.

The binary data for a single symbol is distributed to a plurality of sub-channels and modulated on a sub-channel basis. The data included in each pair of parentheses in portion (a) of FIG. 8 is data for one sub-channel. Portion (b) of FIG. 8 shows each sub-channel signal modulated. As shown in portion (b) of FIG. 8, each sub-channel signal is generated over a single symbol length. The number of phase divisions is defined for each sub-channel signal. A difference in frequency between the carrier signals of the sub-channel signals is an integral multiple of the product of the spatial frequency of the symbol and a relative velocity of the beam spot with respect to the optical disk medium. In the example shown in portion (b) of FIG. 8, the sub-channel signal with the lowest carrier frequency (i.e., the top signal in portion (b) of FIG. 8) has a carrier frequency that is equal to the spatial frequency of the symbol. Thus, a signal for one wavelength has been generated within the symbol. The sub-channel signal with the second lowest carrier frequency (i.e., the middle signal in portion (b) of FIG. 8) has a carrier frequency that is twice as high as the spatial frequency of the symbol. That is to say, a signal for two wavelengths has been generated within the symbol. Likewise, the carrier frequency of each sub-channel signal that follows increases by the spatial frequency of the symbol. Therefore, the carrier frequency of the ninth sub-channel signal is nine times as high as that of the first sub-channel signal. That is to say, the difference in spatial frequency between the carrier signals of each pair of sub-channel signals is a multiple of the spatial frequency of the symbol.

Each sub-channel signal is subjected to phase modulation. In the example shown in portion (b) of FIG. 8, each sub-channel is modulated by 64 QAM (quadrature amplitude modulation), which is an amplitude-phase modulation where each sub-channel may have 64 different amplitudes and phases. That is to say, since six bits can be distributed to each sub-channel, 54 bits (=6 bits×9 sub-channels) can be written per symbol. Alternatively, each sub-channel may also be modulated by PSK (phase shift keying). In that case, resistance to amplitude variations increases and eventually, reliability also increases.

By combining these QAM modulated sub-channel signals, the orthogonal frequency division multiplexed signal shown in portion (c) of FIG. 8 can be obtained. This orthogonal frequency division multiplexed signal is the signal to be written. However, even if a write operation is performed using a write beam of which the intensity is proportional to this signal, the same signal cannot be obtained during a read operation for any of the following three reasons: (1) the write operation itself is two-photon absorption recording, of which the probability is proportional to the square of the intensity of the write beam; (2) the read signal is obtained as a convolution of the intensity pattern of the read beam spot and the refractive index pattern, and therefore, has been filtered; and (3) if the emission interval of the write beam is narrower than the diameter of the write beam spot, some portion may be irradiated with multiple beam spots, which is unique to this write method.

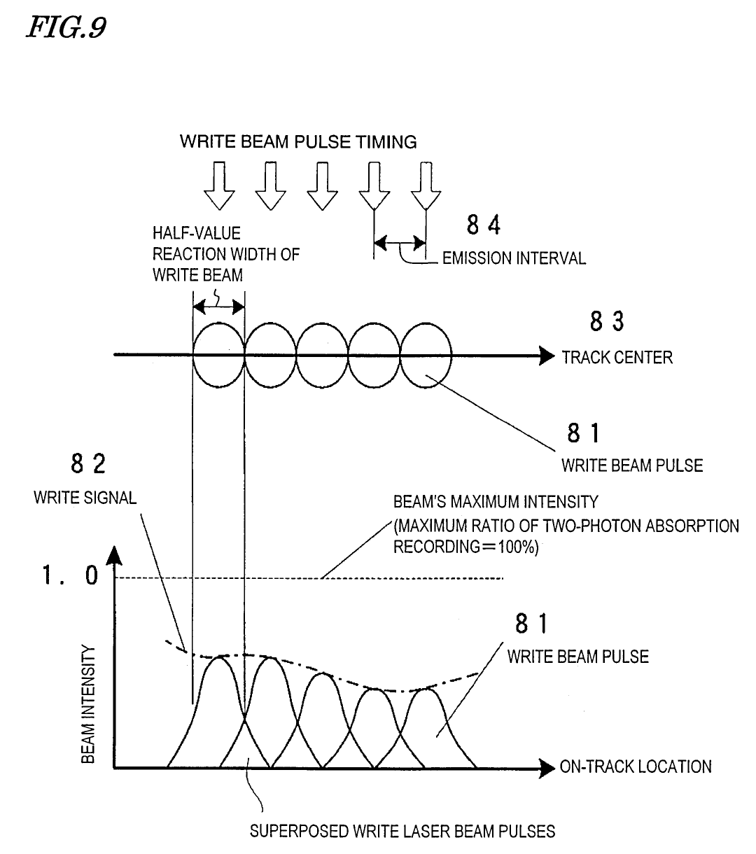

FIG. 9 shows how to perform two-photon absorption recording. According to two-photon absorption recording, the write beam is usually a very short pulse. This is because as the two-photon absorption recording requires high-power write beams, the peak power needs to be increased with the duty decreased. In the example shown in FIG. 9, the write operation is supposed to be performed by irradiating the track center 83 with write beam impulses 81 at regular emission intervals 84. Therefore, a portion between two write beam impulses 81 is irradiated with beams twice. As for the intensities of the beams to be radiated, the intensity at which the probability of the two-photon absorption recording reaction is 100% is the maximum intensity, which is supposed to be 1.0 (and which will be referred to herein as “normalized write beam intensity”). That is to say, at the portion irradiated with that beam, diarylethene molecules will produce two-photon absorption reaction at a probability of 100% but no further reactions are supposed to occur. In the following description, the beam intensity will be represented by the probability of two-photon absorption reaction, i.e., the percentage of recording reaction that starts at 0%. Also, the refractive index when the two-photon absorption recording reaction has occurred 0% is supposed to be 1.55, the refractive index when the two-photon absorption recording reaction has occurred 100% is supposed to be 1.65, and the percentage of the two-photon absorption recording reaction is supposed to be proportional to the refractive index. The write operation is carried out under these conditions. If the write operation is performed using write beam impulses 81, of which the intensities are proportional to the sampled value of the orthogonal frequency division multiplexed signal 82, the same signal as the orthogonal frequency division multiplexed signal 82 cannot be reproduced even by reading the refractive index pattern produced.

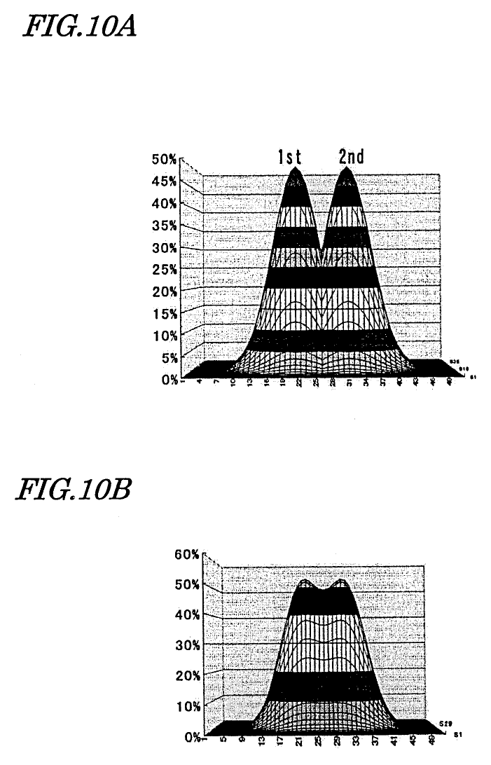

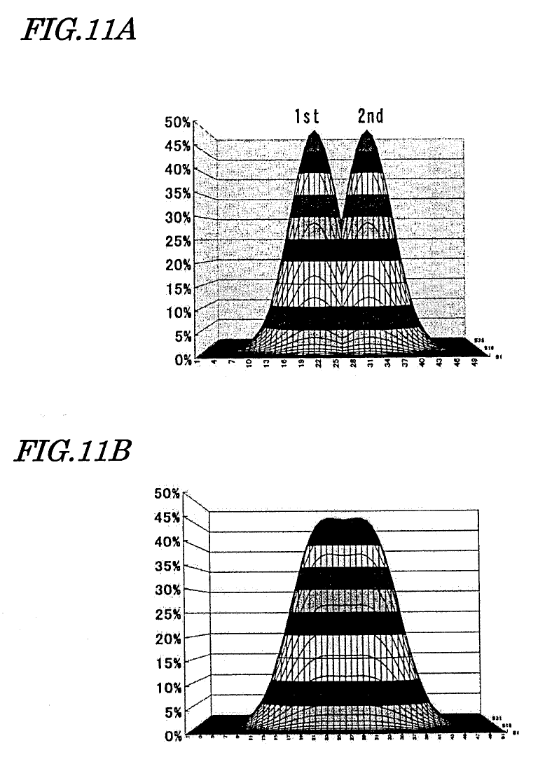

FIGS. 10A and 10B show the simplest example in which refractive index patterns are formed by two-photon absorption recording where two write beam impulses are radiated at an interval that is approximately equal to a half of the airy radius of the write beam. FIG. 10A shows the intensity distribution of the two write beam impulses. Where the write beams overlap with each other, the write beam with the higher beam intensity is shown. These beams are generated when the objective lens has an NA of 0.85 and the laser light source has a wavelength of 650 nm. The ordinate is the beam intensity represented by the percentage of recording reaction. The peak intensity of the write beam impulses is an intensity that causes the recording reaction 50%. In FIG. 10A, the write beam on the left-hand side is radiated first, and then the write beam on the right-hand side is radiated. At an intermediate location between the two beam spots, the intensity of the write beam is an intensity that causes the two-photon absorption recording reaction 28.7%.

FIG. 10B shows the distribution of percentages of the two-photon absorption recording reaction that was carried out using the write beams shown in FIG. 10A. For example, the percentage of the two-photon absorption recording reaction at an intermediate location between the beam spots of the two write beam impulses once decreases to 28.7% in response to the first write beam impulse on the left-hand side and then increases to 49.2% (=28.7%+(100%−28.7%)×28.7%) in response to the second beam impulse on the right-hand side.

FIGS. 11A and 11B show refractive index patterns to be produced when the write beam intensities and the percentages of the two-photon absorption recording reaction have a linear relation. FIG. 11A shows write beam impulses as in FIG. 10A. On the other hand, FIG. 11B shows a refractive index pattern that was produced with these write beam impulses when the write beam intensities and the percentages of the two-photon absorption recording reaction had a linear relation. When calculated as in FIG. 10B, the percentage of two-photon absorption recording reaction at an intermediate location between the beam spots of the two write beam impulses will be 57.4% (=28.7%+28.7%).

Since the two beam impulses have the same intensity, the resultant refractive index distribution should be flat between the beam spots of these two beam impulses. Comparing FIGS. 10B and 11B with each other, it can be seen that the refractive index distribution between the beam spots of the two beam impulses is almost flat in FIG. 11B but has a decline in FIG. 10B. Also, in FIG. 11B, the write beam intensities and the percentages of two-photon absorption recording reaction have a relation defined by simple additions. On the other hand, in FIG. 10B, the total percentage of two-photon absorption reaction is obtained by multiplying the percentage of unreacted molecules in the area where the two-photon absorption recording reaction occurred last time (i.e., 100% minus the percentage of the previous reaction) by the percentage of reaction to be determined by the intensity of the next write beam.

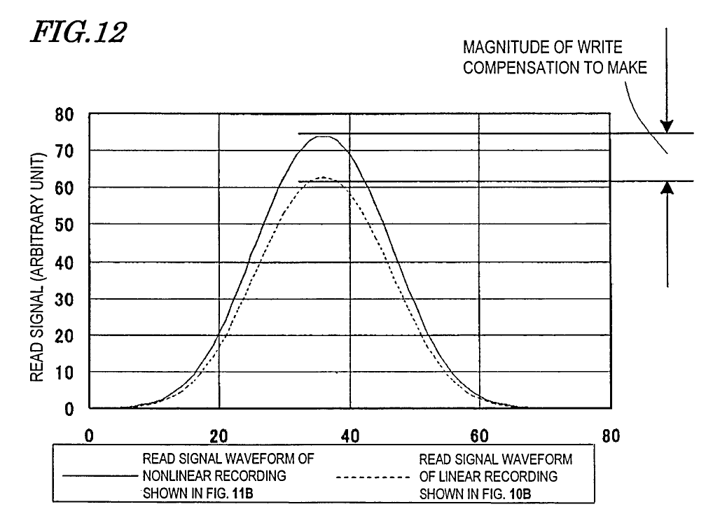

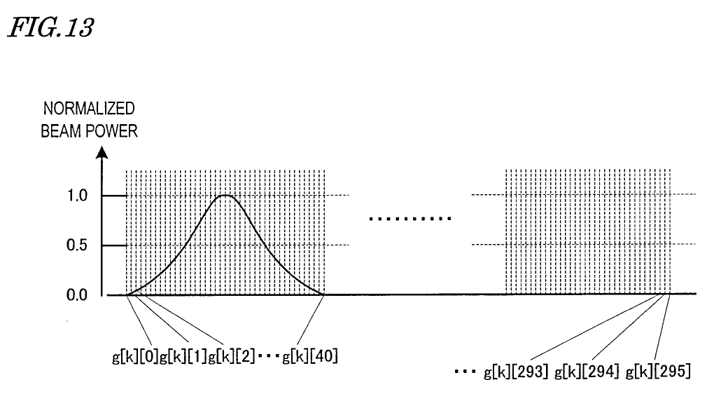

FIG. 12 shows read signals representing reflected light to be produced by scanning the refractive index patterns shown in FIGS. 10B and 11B with a read beam having a constant intensity. The difference between these two read signals results from the non-linearity of the reaction in the area where the write beam overlap with each other. If the write operation is carried out with such overlapping write beams, the write signal will be different from the refractive index pattern produced actually, and write compensation will be required to compensate for the difference. That is to say, the difference between the two signals shown in FIG. 12 corresponds to the magnitude of write compensation to be made.

As the method of write compensation, a write signal that will result in the desired read signal may be figured out asymptotically by hill climbing or any other simulation method. In this case, the desired read signal is similar to the orthogonal frequency division multiplexed signal to be written. The simulation algorithm may have the steps of:

(Step 1) set an initial write signal appropriately, generate write beam impulses by sampling the initial write signal at predetermined intervals, perform a write operation using the impulses, and obtain a refractive index pattern produced;

(Step 2) consider that the write operation is the two-photon absorption recording in which the probability is proportional to the square of the write beam intensity and that the data is written non-linearly by being irradiated with write beam spots a number of times, and obtain a read signal as a convolution of the intensity pattern of a read beam spot and the refractive index pattern;

(Step 3) compare the read signal obtained in step (2) to the desired read signal, and change the write signal such that the read signal obtained approaches to the desired read signal. More specifically, compare the read signal obtained in step (2) to the desired read signal and increase the intensity of the write beam impulse where the read signal obtained has a lower level or decrease the intensity of the write beam impulse where the read signal obtained has a higher level. And at the same time, calculate the integrated value of the absolute values of the differences between the read signal obtained and the desired read signal and use this value as an estimate of the write signal;

(Step 4) perform a write operation as in step (1) using the write signal changed; and

(Step 5) go back to step (2).

These processing steps are repeatedly carried out until the estimate of step (3) becomes equal to or smaller than a predetermined value. As a result, the orthogonal frequency division multiplexed signal shown in portion (c) of FIG. 8 is converted into the write signal shown in portion (d) of FIG. 8. In the write signal curve shown in portion (d) of FIG. 8, the dots represent the beam spots of the write beam impulses.

Portion (e) of FIG. 8 shows a refractive index pattern to be produced when a write operation is performed using the write signal shown in portion (d) of FIG. 8. The write beam spot 71 moves along the track 68. By scanning the track 68 with a beam, of which the intensity is proportional to that of the write signal shown in portion (d) of FIG. 8, the refractive index pattern changes within the track 68 and the binary data shown in portion (a) of FIG. 8 is written.

A method of seeking a solution asymptotically such as the hill climbing method needs s lot of computations. That is why a method of finding a solution more analytically would require fewer computations and figure out the write signal more quickly. Hereinafter, a write compensation method according to a preferred embodiment of the present invention will be described.

The write compensation according to this preferred embodiment of the present invention is characterized by obtaining the intensity pattern of a write beam within a symbol such that a desired orthogonal frequency division modulated wave can be produced during a read operation. The intensity pattern of the write beam can be calculated in two steps. Specifically, in the first step, an optical constant pattern that will result in the desired orthogonal frequency division modulated wave is obtained. Then, in the next step, the intensity pattern of the write beam to record this optical constant pattern is obtained.

First, an optical constant pattern that will result in the desired read signal is obtained. More specifically, an optical constant pattern for one symbol, in which an orthogonal frequency division modulated wave is produced as a read wave, is obtained. In this example, the optical constant is refractive index, a Gaussian beam is used as a read beam, and a read signal is supposed to be obtained by scanning the refractive index pattern with a continuously radiated read beam. The read signal is obtained by performing a convolution operation on the refractive index pattern using the read beam. Thus, its inverse convolution operation may be performed.

FIG. 13 shows parameters within one symbol that are related to a read operation. The calculations should be done two-dimensionally, considering that the read/write operation is performed two-dimensionally. In this example, however, track center values are calculated as representative values. g[k][L] represents the normalized beam power of a Gaussian read beam at a sample point L at the k^{th} sampling timing. In this case, the peak power of the Gaussian read beam is normalized as 1.0. Rf[L] represents the reflectance at the sample point L on the recording layer where data is stored. The reflectance has a value corresponding to the refractive index. Plysg[L] represents the ratio of the reflected light to the radiated light when the k^{th} beam [k][L] of the read light is radiated. That is to say, supposing the read beam has constant power, this ratio will be equivalent to the read signal. That is why this ratio will be referred to herein as a “read signal”. Plysg[L] is the L^{th} sample value of the read signal. In the example shown in FIG. 13, there are 256 sample points.

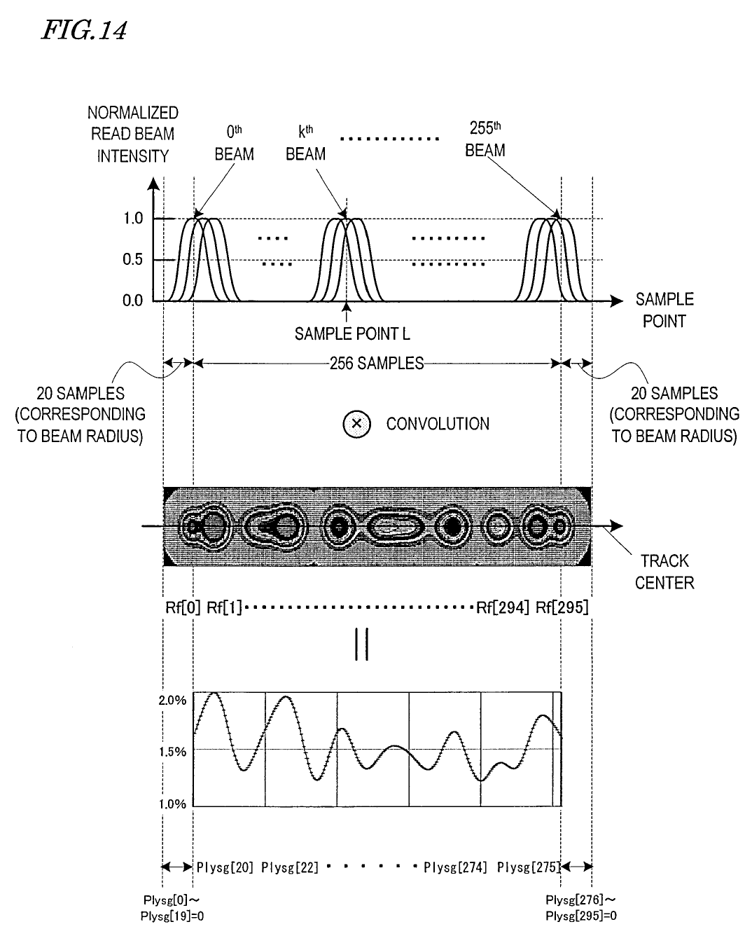

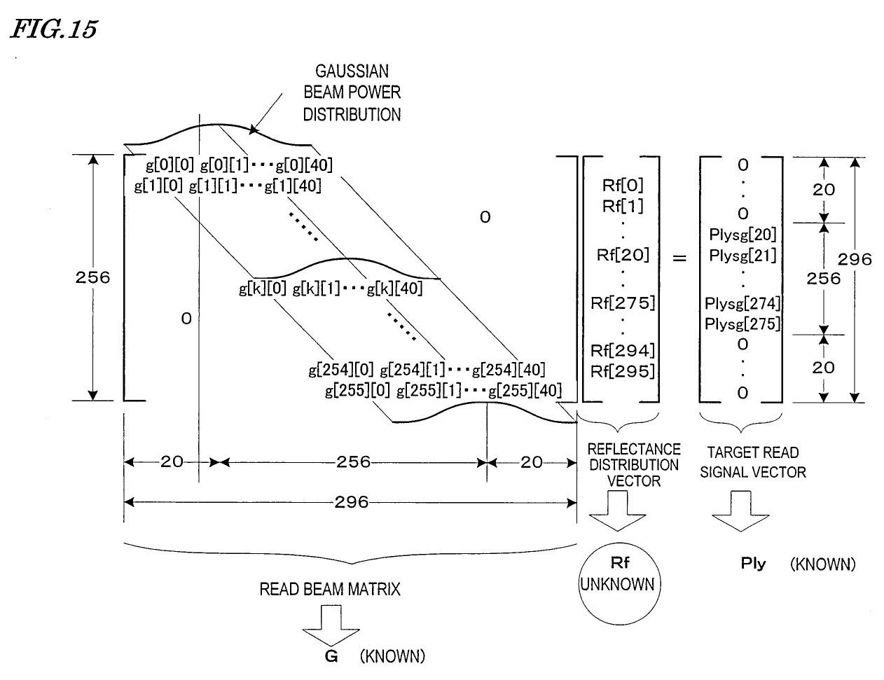

FIG. 14 shows a process by which a read signal is obtained by scanning a single symbol with a read beam. In this example, the read beam is supposed to be radiated continuously at a constant intensity and the read signal is supposed to be sampled 256 times within a single symbol length. The upper portion of FIG. 14 shows the distributions of the zeroth beam g[0][L] through the 255^{th} beam g[255][L] of the read light at those sample points. Portions for the beam radius of the read light before and after the symbol (i.e., the areas for 20 samples before and after the symbol) are also irradiated with the read light. Since the read light has constant intensity, the converged portion of g[k][L] also has a constant distribution.

The middle portion of FIG. 14 shows the reflectance pattern (refractive index pattern) recorded within a symbol. The reflectance is determined by the refractive index. For example, if the refractive index in a situation where the two-photon absorption reaction has occurred 0% on the recording layer is N1, the refractive index in a situation where the two-photon absorption reaction has occurred 100% there is N2, the portions that sandwich the recording layer vertically is N0, the wavelength of the read beam is λ, the thickness of the recording layer is D, the normalized refractive index is n[L] (which is normalized to be 0 at the refractive index N1 and to be 1.0 at the refractive index N2) and N12=N1+(N2−N1)×n[L], then the reflectance Rf[L] of the portion with the normalized refractive index n[L] is:

1−(8×N0̂2×N12̂2/(N12̂2+N0̂2)̂2+4×N0̂2×N12̂2−(N0̂2−N12̂2)̂2×cos(4×π×N12×D/λ)))

Since N1, N2, N0, λ and D are known and constant, the reflectance Rf[L] and the normalized refractive index n[L] have one-to-one correspondence. That is why the pattern shown in this middle portion will be referred to herein as a “reflectance pattern”.

The lower portion of FIG. 14 shows a read signal obtained by irradiating the reflectance pattern shown in the middle portion of FIG. 14 with the read beam shown in the upper portion of FIG. 14. This read signal is obtained by performing a convolution operation on the read beam distribution shown in the upper portion of FIG. 14 using the reflectance pattern shown in the middle portion of FIG. 14.

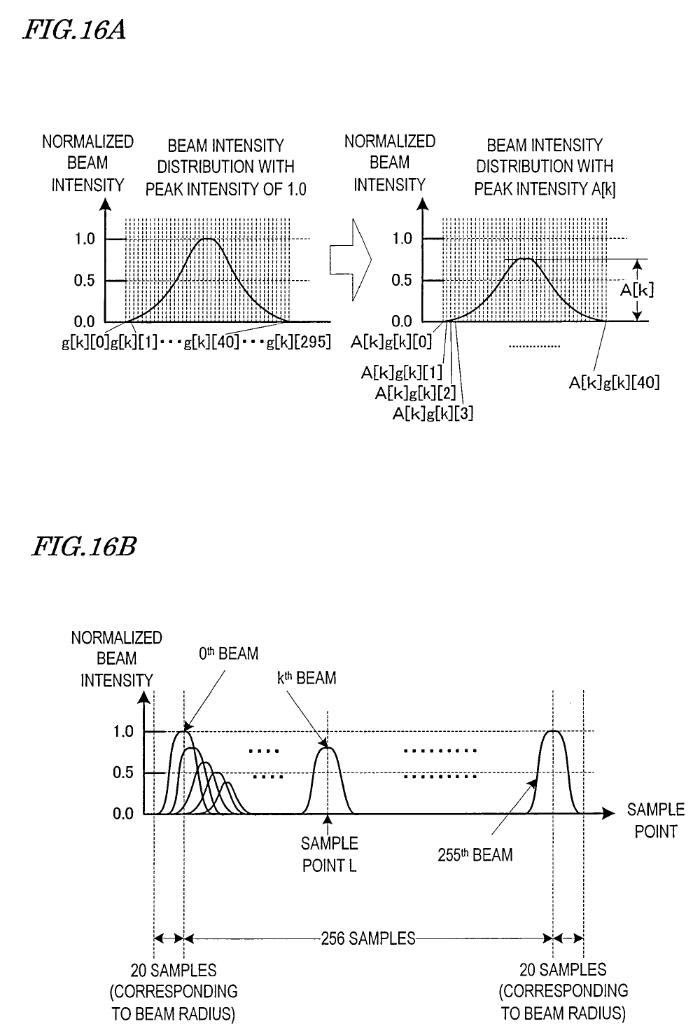

Taking these results into consideration, the relation between the read beam, the reflectance distribution and the read signal for a single symbol can be represented by the matrix equation shown in FIG. 15, in which the matrix on the left-hand side will be referred to herein as a “read beam matrix”, the matrix on the right-hand side will be referred to herein as a “read signal vector” and the middle matrix will be referred to herein as a “reflectance distribution vector”. Since the read beam matrix and the read signal vector are known, the reflectance distribution vector can be obtained by multiplying both sides of the equation with the inverse matrix of the read beam matrix from left to right.

Next, the intensity pattern of the write beam that forms this optical constant pattern, i.e., the refractive index pattern, will be obtained.

Consider how the refractive index at a particular location varies with the write beam. The normalized intensity of the write beam that irradiates the particular location for the k^{th} time is supposed to be b[k] and the normalized refractive index after the write beam has been radiated for the k^{th} time is supposed to be n[k]. As used herein, the “normalized write beam intensity” is supposed to be a beam intensity that causes the two-photon absorption recording reaction 100% when b[k]=1.0 as in FIG. 9 and is supposed to have a linear value. Likewise, the “normalized refractive index” is supposed to be a refractive index that causes the two-photon absorption recording reaction 100% when n[k]=1.0 and is supposed to have a linear value. Then, based on the refractive index after the write beam has been radiated for the (k−1)^{th} time, the refractive index after the write beam has been radiated for the k^{th} time can be calculated as:

n[k]=n[k−1]+(1−n[k−1])×b[k]̂2

This equation can be modified into:

(1−n[k])=(1−n[k−1])×(1−b[k]̂2)

This is a kind of a geometrical series. If N[k]=1−n[k], then

N[k]=N[k−1](1−b[k]̂2)

Therefore, N[k] can be represented by b[0] through b[k]. That is to say,

N[k]=N[0](1−b[0]̂2)×(1−b[1]̂2)× . . . ×(1−b[k−1]̂2)×(1−b[k]̂2)

N[0] shows 1−n[0]. Consequently, if the initial refractive index and the write beam intensity at a particular point are known, the refractive index after the write beam has been radiated for an arbitrary number of times can be calculated.

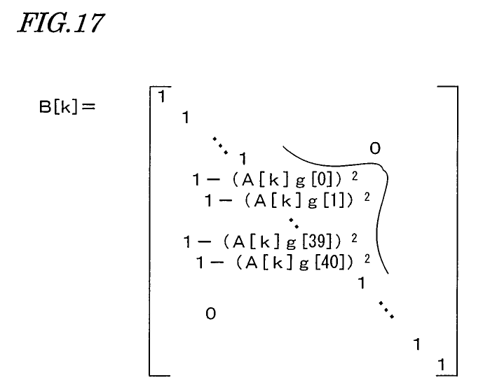

In the same way, if the intensity of the write beam is known, the refractive index pattern recorded within a symbol can also be calculated analytically. FIGS. 16A and 16B show parameters when a single symbol is recorded. In this example, the write beam is supposed to be radiated as pulses toward the same locations as the read sample points, and 256 pulses are supposed to be radiated per symbol. The 20 samples (corresponding to the radius of a write beam) before the 256 sample interval irradiated with the write beam and another 20 samples after the 256 sample interval are written with the perimeter portion of the write beam.

The parameters are re-defined by adding location parameters to the parameters of the beam distribution described above. Suppose the normalized intensity of the write beam radiated toward a sample point L for the k^{th} time is b[k][L], the normalized refractive index after the sample point L has been irradiated with the write beam for the k^{th} time is n[k][L], and N[k][L]=1-n[k][L]. Also, the normalized beam power distribution of the write beam at the sample point L is g[k][L] (of which the peak beam power is supposed to be 1.0). A[k] shows the peak power of the k^{th} beam. The beam power distribution of the k^{th} write beam is represented by A[k]×g[k][L]. FIG. 16A shows the distribution of A[k]×g[L]. Since the g[k][L] shows a Gaussian distribution and is already known, the write beam distribution can be represented only by A[k].

FIG. 16B shows the locations of write light beams within a single symbol. The beam spots of the write beam are located at their associated sample points of the read beam. That is why the sample points L are defined from 0 through 295. Unlike the read beam, however, the intensity of the write beam is not constant but variable.

Also, the beam power distribution of one pulse of the write beam within a single symbol can be represented by the matrix equation shown in FIG. 17. This matrix will be referred to herein as a “beam matrix” and defined as B[k]. In this example, the g[k][L] distribution is supposed to be a Gaussian distribution. Alternatively, this distribution may be optimized for read/write learning.

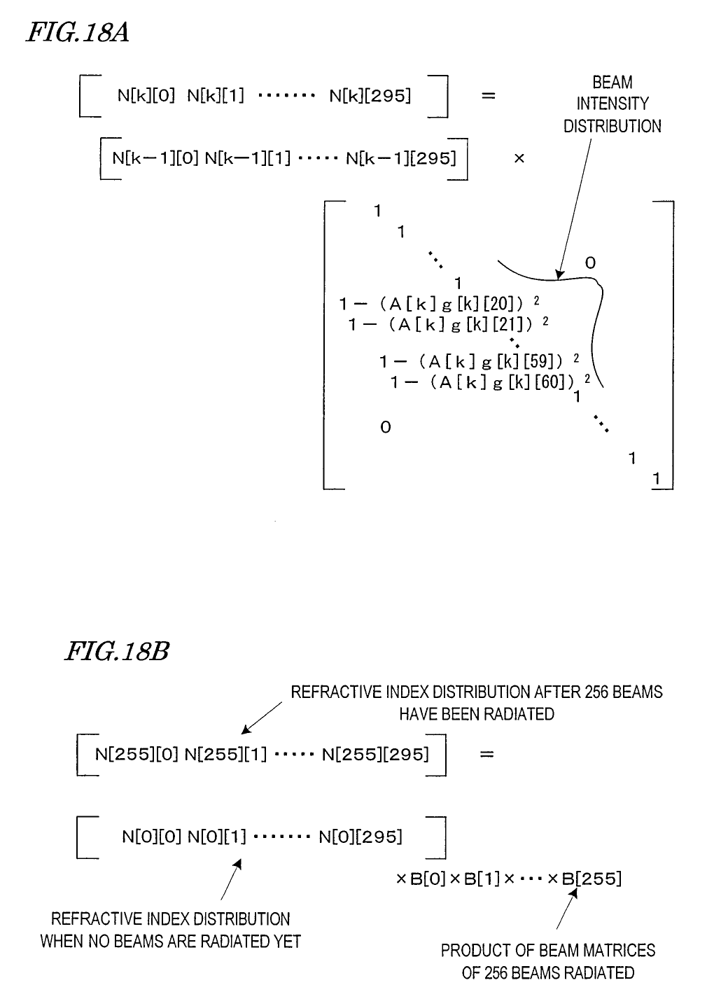

Using these re-defined parameters, the refractive index distribution after the k^{th} write beam has been radiated is obtained based on the refractive index distribution after the (k−1)^{th} write beam has been radiated and the beam power distribution of the k^{th} write beam. In FIG. 18A, the refractive index distribution after the k^{th} write beam has been radiated is calculated by a matrix equation based on the refractive index distribution after the (k−1)^{th} write beam has been radiated and the beam matrix of the k^{th} write beam. N[k][0]=1−n[k][0] where n[k][0] is the normalized refractive index at the sample point 0 after the k^{th} beam has been radiated. In this case, refractive index variation matrix represented by the k^{th} beam power distribution b[k][ ]≡beam distribution matrix≡B[k].

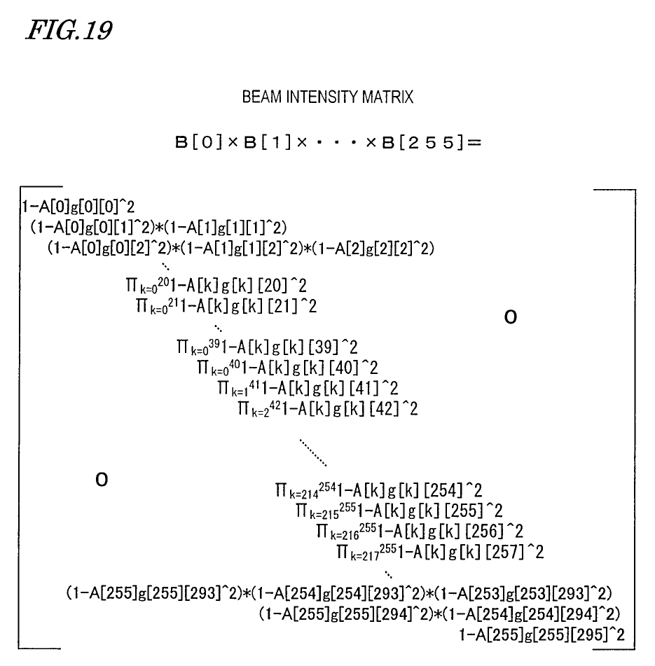

The refractive index distribution within a single symbol after the k^{th} write beam has been radiated is represented by the matrix equation shown in FIG. 18B. In this case, since every zeroth refractive index distribution is equal to zero, every N[0][L] is equal to one. The matrix equation is eventually transformed into the matrix equation shown in FIG. 19. According to this matrix equation, if A[k] is known, then the desired write beam intensity pattern can be obtained. This matrix equation can be solved quickly by the Newton-Lapson method.

As described above, the target read signal vector, obtained by substituting the target read waveform into plysg shown in FIG. 15, is multiplied by the inverse matrix of the ream beam matrix G to calculate a reflectance distribution vector. Thereafter, the reflectance is converted into a refractive index, which is then substituted into the refractive index distributions shown in FIGS. 18A and 18B after the write beams have been radiated 256 times, thereby obtaining beam matrices A[0] through A[255] by the Newton-Lapson method, for example. As a result, a write beam intensity can be obtained and reflected on the write-compensated write signal.

By formulating the write compensation computations into a mathematical equation and solving that equation as described above, the write beam intensity pattern can be calculated quickly so as to obtain the desired orthogonal frequency division modulated waveform. As a result, a write-compensated write signal can be obtained.

The optical disk drive 100 shown in FIG. 7 performs the write compensation described above. Hereinafter, it will be described in detail how the optical disk drive 100 operates.

The modulating section 101 includes a turbo code modulator 91 and an orthogonal frequency division modulator 93. The write compensation section 95 includes a refractive index pattern calculator 96 and a write pulse intensity calculator 98. The optical head section 103 includes a pulse laser driver 110, a pulse laser diode 112, a collimator lens 113, a beam splitter 114, a quarter wave plate 115, an objective lens 116, an objective lens actuator 117, a condenser lens 121, a group of photosensors 122 and a servo circuit 126. The optical disk medium 118 including the recording layer 119 is rotated by the spindle motor 120.

In reading information from the optical disk medium, the optical head section 103 serves as a read section, which irradiates the recording layer with a beam and generates a read signal based on the light that has been reflected from the optical disk medium. The optical disk drive 100 further includes a demodulating section 104, which multiplies the read signal, generated by the optical head section 103, by a plurality of carrier signals, thereby generating a plurality of sub-channel signals associated with the carrier signals. Also, the demodulating section 104 detects the information stored on the information storage medium based on those sub-channel signals. The read operation will be described later.

Hereinafter, the write compensation operation performed by the optical disk drive 100 will be described.

The data to be written (i.e., the write data) is input from an information source coding block (not shown) to the turbo code modulator 91 (see FIG. 7), which modulates the data into a high-coding-efficiency turbo code as disclosed by H. Ogiwara and M. Yano, “Improvement of Turbo Trellis-Coded Modulation System”, IEICE Trans. Fundamentals, E-81-A, pp. 2040-2046, 1998. The turbo code for use in wireless communications normally has a coding efficiency of about 0.3 to about 0.5, which is lower than that of optical disks (of about 0.8). The channel of optical disks has a low pass filter characteristic, which makes it difficult to increase the recordable frequency. That is why if the coding efficiency is low, the resultant recording density will also be low. For that reason, the high-coding-efficiency turbo code is used. As the internal code of the high-coding-efficiency turbo code, a code for converting 5-bit data into a 6-bit ungerboeck code is used. The ungerboeck code is disclosed by G. Ungerboeck, “Channel Coding with Multilevel/Phase Signals”, IEEE Trans. Inform. Theory, Vol. IT-28, No. 1, pp. 55-67, January 1982.

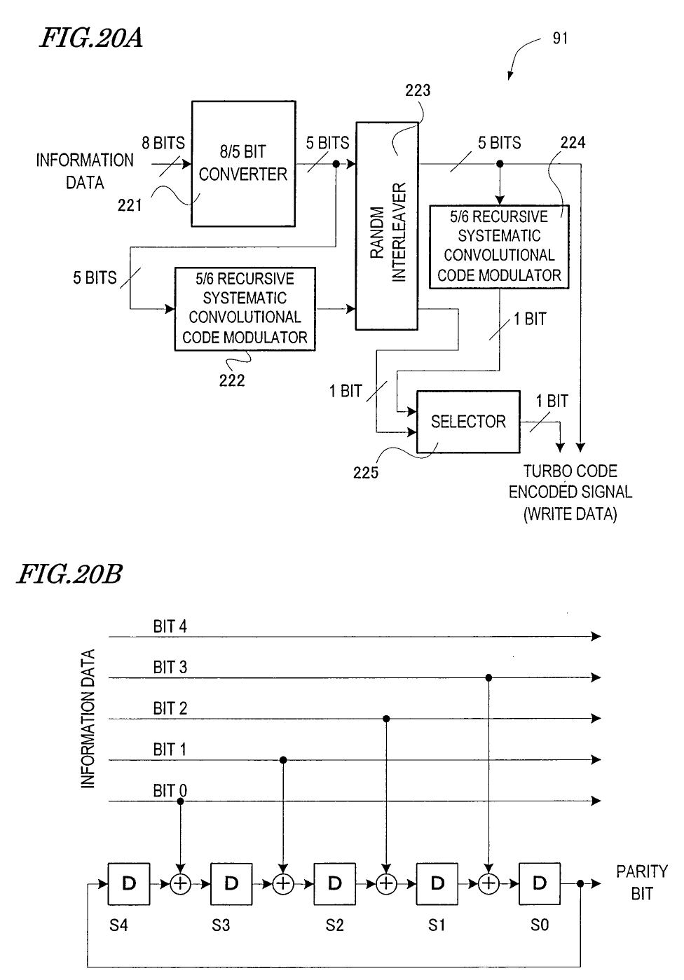

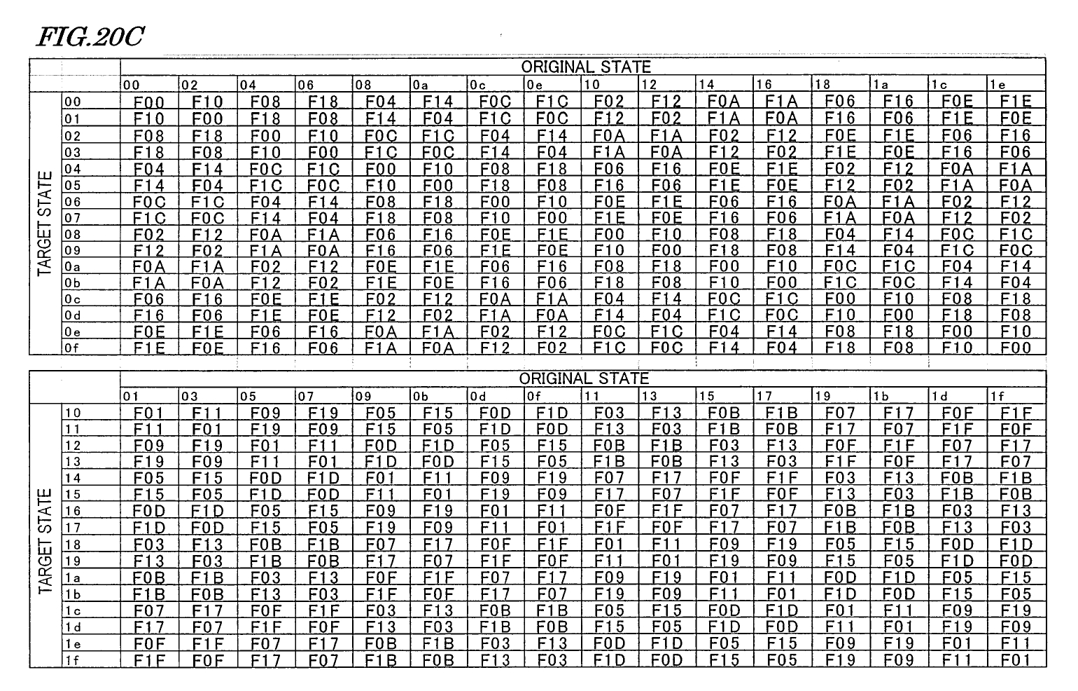

FIG. 20A shows the turbo code modulator 91. In this example, the write data is input as eight-bit parallel data. The eight-bit write data is input to an 8/5 bit converter 221, which converts the eight-bit write data into five-bit parallel data. The converted five-bit data is then supplied to a ⅚ recursive systematic convolutional code modulator 222 and a random interleaver 223.

The ⅚ recursive systematic convolutional code modulator 222 receives the five-bit write data and outputs a single parity bit of a six-bit recursive systematic convolutional code. FIG. 20B shows an exemplary recursive systematic convolutional code modulator. In FIG. 20B, D denotes a D-flip-flop, which operates in response to a clock signal, of which the frequency is nine times as short as one symbol period. That is to say, one OFDM symbol is made up of nine turbo codewords. In the turbo code modulator 91, the 8/5 bit converter and the circuits that follow it all operate responsive to this clock signal. Also, in FIG. 20B, the “+” sign indicates adding one bit. The output parity bit is the input for the leftmost flip-flop, thereby realizing the recursive operation. The modulated data has five-bit data and a single parity bit, but only the single parity bit is output.

FIG. 20C shows the state transition table of the ⅚ recursive systematic convolutional code modulator 222. In this table, the respective states represent the values S4, S3, S2, S1 and S0 of the flip-flops shown in FIG. 20B. Also, in the alphanumeric codes beginning with F on this table, the numerical parts thereof are hexadecimal numbers corresponding to the output values shown in FIG. 20B (i.e., bit 4, bit 3, bit 2, bit 1, bit 0 and parity bit) and the letter F indicates the mapping of the 64 QAM to be described later.

The random interleaver 223 rearranges the arrangement order of input data/its associated parity bit pairs at random on a pair-by-pair basis. The interleave length corresponds to m symbols and is ordinarily less than one track round length. In this example, one codeword is supposed to be made up of six bits and one interleave length is supposed to be made up of 255×129 words (=197,370 bits). This interleave unit will be referred to herein as “one turbo codeword”.

The random interleaver 223 supplies the randomly rearranged data to another ⅚ recursive systematic convolutional code modulator 224. In this case, the ⅚ recursive systematic convolutional code modulators 222 and 224 have the same circuit. That is why the ⅚ recursive systematic convolutional code modulator 224 also outputs a single parity bit. The parity bits supplied from the two ⅚ recursive systematic convolutional code modulators are input to the selector 225, which selectively outputs the two parity bits alternately. That is to say, this turbo code is a puncture code.

The alternately output single parity bit and the five-bit data, supplied from the random interleaver 223, are output as a turbo code modulated signal 92 including six-bit parallel data to the orthogonal frequency division modulator 93.

Since this turbo code modulator 91 receives five-bit write data and outputs a six-bit turbo code, the coding rate is ⅚=0.83.

The orthogonal frequency division modulator 93 modulates the input turbo code modulated signal 92, including the six-bit parallel data, after having distributed the data to the respective sub-channels, and outputs an orthogonal frequency modulated signal 94 in which the modulated data has been added to the respective sub-channels.

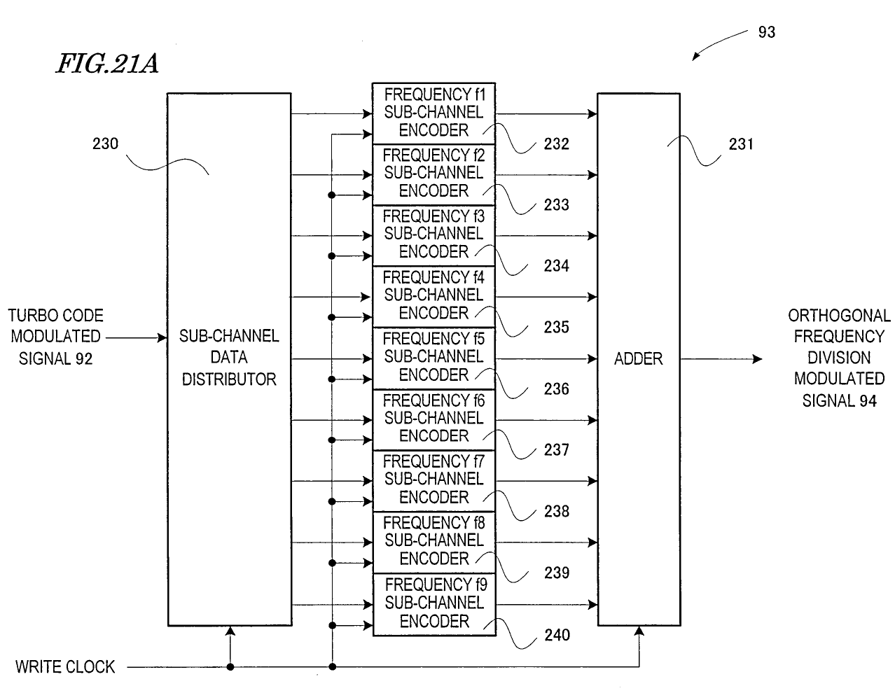

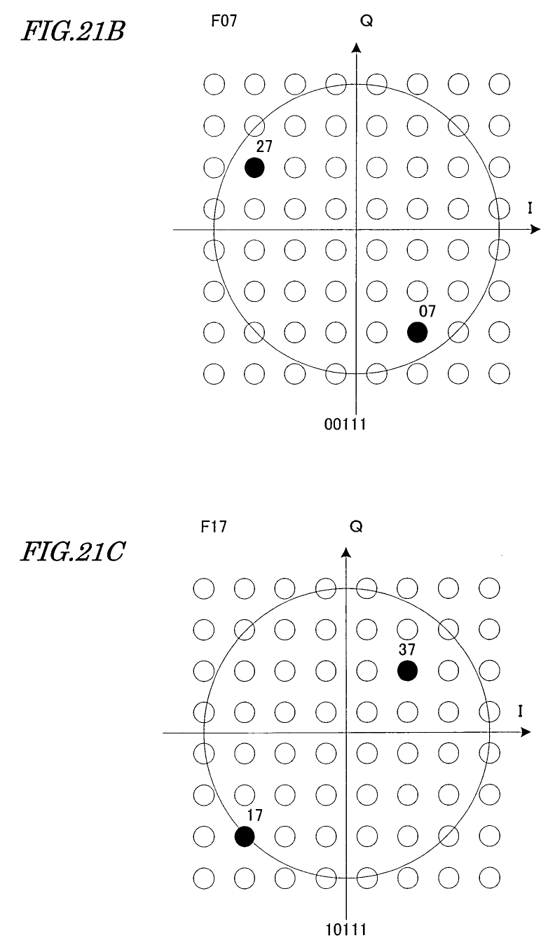

FIG. 21A shows the orthogonal frequency division modulator 93. The incoming turbo code modulated signal is supplied to a sub-channel data distributor 230, which sequentially and repeatedly distributes the six-bit parallel data of the input turbo code modulated signal to frequency f1 to f9 sub-channel encoders 232 to 240.

The frequency f1 through f9 sub-channel encoders 232 through 240 receive the six-bit parallel data and a write clock signal from the sub-channel data distributor 230, and subject the six-bit parallel data to the 64 QAM modulation with carriers having respective frequencies (e.g., frequency f1 for the frequency f1 sub-channel encoder 232), thereby outputting 64 QAM modulated waveform signals synchronously with the write clock signal. The frequency fw of the write clock signal and the carrier frequencies fsc (=f1 through f9) satisfy the following equation (f1:n=1, f9:n=9):

fsc=fw/(n×2^{m})

where n=1, 2, 3, . . . and 9 and n and m are natural numbers.

The frequency f1 through f9 sub-channel encoders 232 to 240 output the 64 QAM modulated waveform signals to an adder 231, which outputs the sum as the orthogonal frequency division modulated signal 94 responsive to every pulse of the write clock signal. FIGS. 21B and 21C show portions of the 64 QAM modulation mapping. The alphanumeric code beginning with F (such as F07) indicates what part of the state transition table of the ⅚ recursive systematic convolutional code modulator 222 shown in FIG. 20C is output. In FIGS. 21B and 21C, there are two outputs (solid black signal points) in a single mapping diagram because bit 4 has two values in FIG. 20B. The orthogonal frequency division modulated signal 94 is input to the write compensation section 95.

The write compensation section 95 is made up of the refractive index pattern calculator 96 and the write pulse intensity calculator 98. The refractive index pattern calculator 96 receives the orthogonal frequency division modulated signal 94 and outputs a refractive index signal 97. The write pulse intensity calculator 98 receives the refractive index signal 97 and outputs a write signal 99.

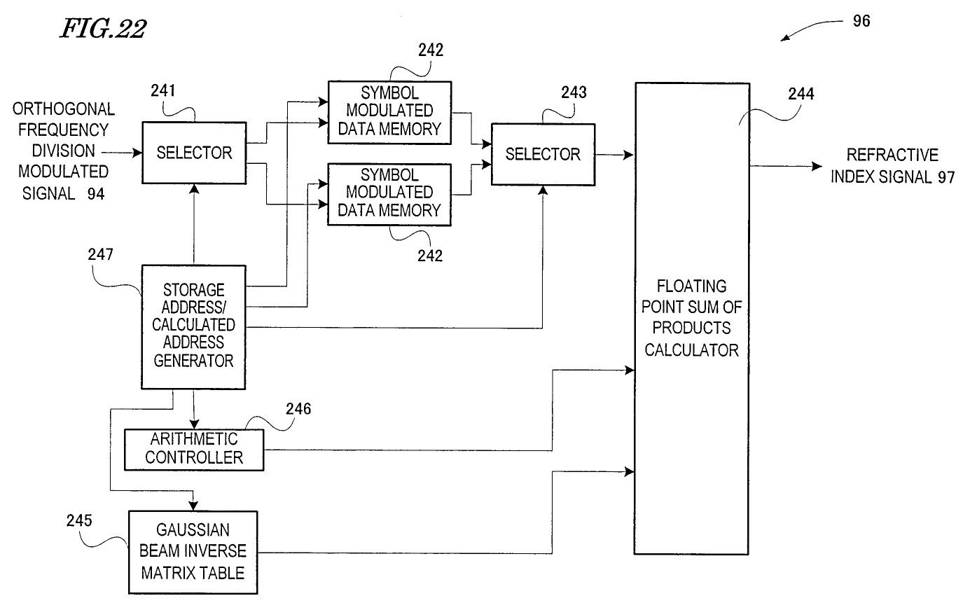

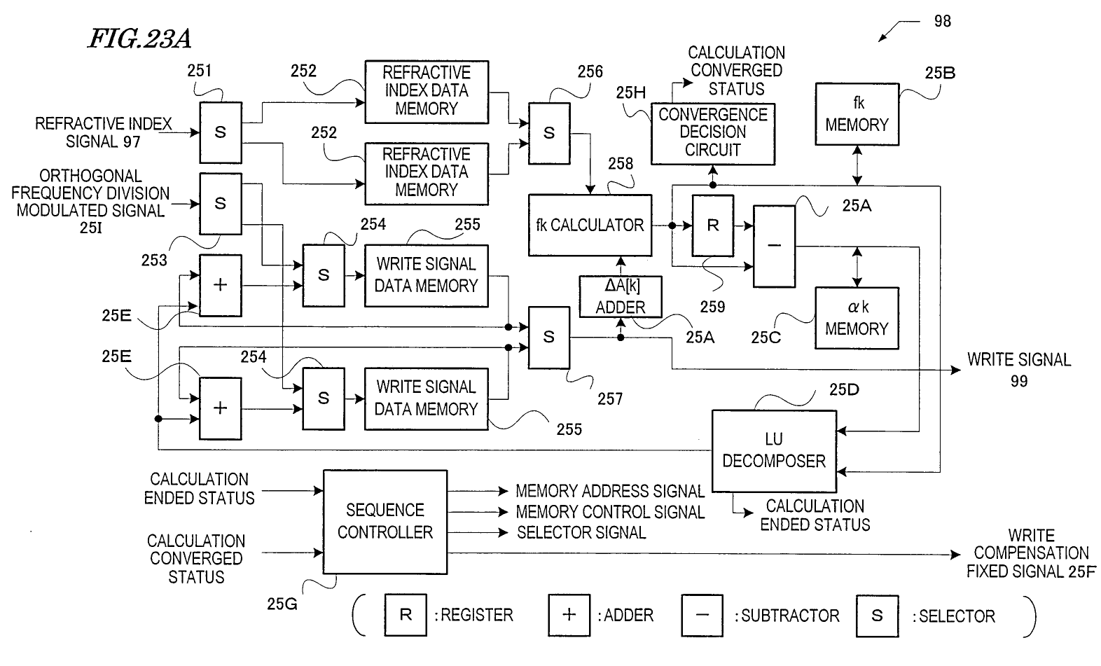

FIG. 22 shows the refractive index pattern calculator 96, in which an inverse matrix of the read beam matrix has been calculated and stored in advance in a Gaussian beam inverse matrix value table 245. By calculating the matrix product of the inverse matrix of the read beam matrix and the orthogonal frequency division modulated signal 94, the refractive index signal can be figured out.

The input orthogonal frequency division modulated signal 94 is once stored in a symbol modulated data memory 242 by way of a selector 241. The symbol modulated data memory 242 has double buffers. That is to say, while the orthogonal frequency division modulated signal 94 is being written on one symbol modulated data memory 242, the other symbol modulated data memory 242 is calculating the refractive index pattern. The orthogonal frequency division modulated signal 94 that has been output from the symbol modulated data memory 242 is supplied to a floating point sum of products calculator 244 by way of a selector 243.

The floating point sum of products calculator 244 performs floating point multiplications and additions and stores and outputs the results of the calculations so as to calculate the matrix products of the output values of the Gaussian beam inverse matrix value table 245 and the orthogonal frequency division modulated signal 94. Data reading for the purpose of calculating the matrix products is controlled using the addresses output by a storage address/calculated address generator 247 to the symbol modulated data memory 242 and to the Gaussian beam inverse matrix value table 245. The sum-of-products calculations are controlled in accordance with a sum-of-products calculation instruction issued by an arithmetic controller 246 to the floating point sum of products calculator 244. When the matrix product has been calculated, the symbol modulated data memories 242 and the selector 243 are switched to calculate the matrix product of the orthogonal frequency division modulated signal stored in the other symbol modulated data memory 242.

The refractive index signal 97 that has been output from the refractive index pattern calculator 96 is input to the write pulse intensity calculator 98. Receiving the refractive index signal 97 and its associated orthogonal frequency division modulated signal 94, the write pulse intensity calculator 98 solves the simultaneous equations shown in FIG. 19 (i.e., obtains A[k] shown in FIG. 19), thereby outputting a write-compensated write signal 99. In this example, the Newton-Lapson method is adopted to obtain A[k] shown in FIG. 19.

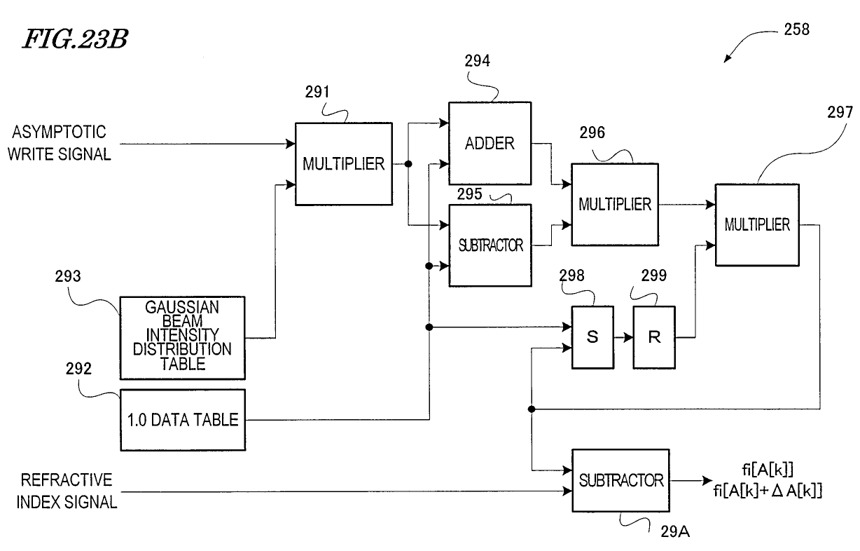

The write pulse intensity calculator 98 shown in FIG. 23A is a hardware component for solving the Newton-Lapson equations using the orthogonal frequency division modulated signal as an initial value. The refractive index signal 97 that has been input to the write pulse intensity calculator 98 is written in a refractive index data memory 252 by way of a selector 251. At the same time, an orthogonal frequency division modulated signal 25I, generated by a timing regulator (not shown) based on the orthogonal frequency division modulated signal 94 and the refractive index signal 97, is written on a write signal data memory 255 by way of selectors 253 and 254. The orthogonal frequency division modulated signal 25I is input as an initial value of the write signal. The data stored in the write signal data memory will be referred to herein as an “asymptotic write signal”. The refractive index data memory 252 has double buffers, so does the write signal data memory 255. That is to say, while the refractive index signal 97 is being written in one refractive index data memory 252, the other memory is calculating the write signal. Also, while the orthogonal frequency division modulated signal 25I is being written on one write signal data memory 255, the other memory is calculating the write signal.

The refractive index signal that has been output from the refractive index data memory 252 is input to an fk calculator 258 by way of a selector 256. The asymptotic write signal that has been output from the write signal data memory 255 is also input to the fk calculator 258 by way of a selector 257 and a ΔA[k] adder 25A. The ΔA[k] adder 25A adds zero or a predetermined constant to the asymptotic write signal in a prescribed sequence. That is to say, the write signal data memory outputs asymptotic write signals once (zero added) plus 256 times (A[k]) corresponding to one equation shown in FIG. 19. Either zero or a predetermined constant is added to each asymptotic write signal value and the sum is input to the fk calculator 258, which performs the left-side calculations of the simultaneous equations shown in FIG. 19 on the asymptotic write signal to which either zero or the predetermined constant has been added. In this example, the asymptotic write signal to which zero has been added is output first, and then the sums to which k=0 through 255 have been added are output sequentially.

The zero-added value that has been output from the fk calculator 258 is stored in a register 259 and written in an fk memory 25B. A subtractor 25J subtracts the fk calculated values of the following asymptotic write signals, to which ΔA[k] has been added, from the value stored in the register 259 and writes the remainders in an αk memory 25C. 256 values corresponding to one equation shown in FIG. 19 are stored in the fk memory, while 65,536 (=256×256) values are stored in the αk memory.

FIG. 23B shows the fk calculator 258. The input asymptotic write signal is supplied to a multiplier 291, which multiplies the asymptotic write signal by a value that has been read out from a Gaussian beam intensity distribution table 293 in a predetermined sequence and outputs the product. This calculation corresponds to the A[k]×g[L] portion shown in FIG. 19. The output signal of the multiplier 291 is supplied to an adder 294 and a subtractor 295, which respectively add and subtract a value of 1.0, supplied from a 1.0 data table 292, to/from the signal supplied. And the resultant sum and remainder are input to, and multiplied together by, a multiplier 296. This calculation corresponds to the 1−A[k]g[L]̂2 portion shown in FIG. 19. The output of the multiplier 296 is supplied to another multiplier 297, which multiplies it by a value supplied from a register 299 and then outputs the product to a subtractor 29A and to the register 299 by way of a selector 298. The register 299 stores the result of the previous multiplication done by the multiplier 297 and has an initial value of 1.0, which has been supplied from the 1.0 data table 292 by way of the selector 298. When multiplications for one symbol are done in a predetermined sequence, the subtractor 29A subtracts the refractive index signal value from the output of the multiplier 297 and outputs the remainder.

When these operations are performed for one symbol, 256 fk values and 65,536 αk values for one symbol are output to an LUV decomposer 25D that solves the following simultaneous equations including the fk and αk values:

−fk=αk×xk

These equations will be 256 simultaneous equations. The resultant xk is input to an adder 25E, which adds it to the asymptotic write signal stored in the write signal data memory 255. Then, the resultant sum is written on the write signal data memory 255 again. As a result of this write operation, the value of the asymptotic write signal is updated to approach to the write-compensated write signal.

By repeatedly performing this calculation loop, the fk value goes closer and closer to zero, which means that the asymptotic write signal is approaching to the write compensated value. When a convergence decision circuit 25H senses that the fk value is equal to or smaller than a predetermined value, this calculation loop ends, the write-compensated write signal 99 and a write compensation fixed signal 25F are output, and the calculations are started all over again by switching to the other refractive index memory 255 and the other write signal data memory 255.

The write signal 99 that has been output from the write compensation section 95 and the write clock signal 135 are supplied to a pulse laser driver 110, which generates a pulse laser drive signal 111 based on the write signal 99 supplied. The pulse laser drive signal 111 is synchronous with the write clock signal 135. The pulse laser diode 112 transforms the pulse laser drive signal 111 into a laser beam. Since the two-photon absorption recording requires a laser beam with very high peak power, the pulse width should be much smaller than one period of the write clock signal and may be about 1 ns, for example.

The laser beam emitted from the pulse laser diode 112 is transformed into a parallel beam by the collimator lens 113, passed through the beam splitter 114 and the quarter wave plate 115, and then incident on the objective lens 116.

The objective lens 116 is controlled by the objective lens actuator 117 so as to focus the laser beam on the recording layer 119. The laser beam that has been focused on the recording layer 119 changes the composition of the recording layer 119, thereby varying the refractive index and writing data there.

In the foregoing description, every data is supposed to be floating point data. However, as long as the error can be estimated, calculations may also be done on fixed point data as well.

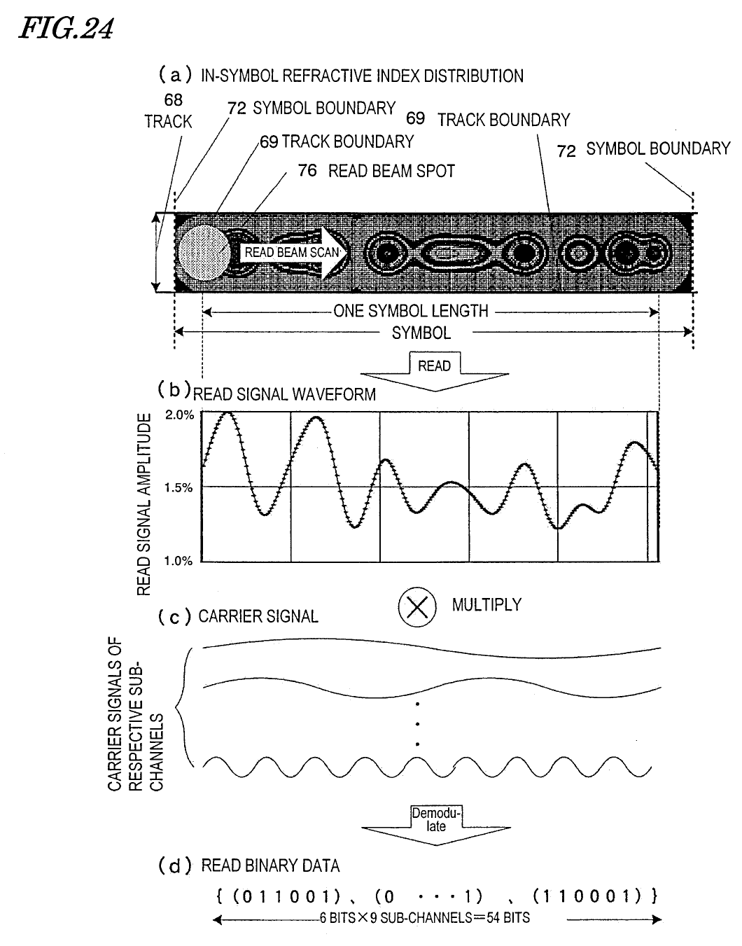

Next, a reading method according to the present invention will be described. FIG. 24 shows an optical reading method according to the present invention. Specifically, Portion (a) of FIG. 24 shows a refractive index pattern produced by the writing method shown in FIG. 8. The binary data shown in portion (d) of FIG. 24 is read from this refractive index pattern. Hereinafter, the procedure of reading the stored binary data will be described with reference to portions (a) through (d) of FIG. 24 sequentially.

Portion (a) of FIG. 24 shows the refractive index pattern of a single symbol that is defined by symbol boundaries 72 and track boundaries 69. In this symbol, also stored is binary data of 54 bits. The read beam spot 76 with its intensity fixed at a constant value moves along the centerline of the track 68 of this symbol. And by detecting the reflected light of this read beam spot 76, a read signal waveform can be obtained.

Portion (b) of FIG. 24 shows the waveform of a read signal for one symbol. The length of this read signal waveform for one symbol (i.e., one symbol length) is different from the distance between the symbol boundaries. Portions (a) and (b) of FIG. 24 show the read signal and the location of the read beam in association with each other. One symbol length is the length of an interval during which a signal for one symbol is read or written. Also, one symbol length is the distance from the center of the beam reading the top portion of the read signal shown in portion (b) of FIG. 24 through that of the beam reading the end portion of that read signal. The distance between the symbol boundaries is a physical length where data is stored and is longer than the sum of the symbol length and the diameter of the write beam spot. This difference is caused because the write beam spot and the read beam spot have finite sizes.

By multiplying the read signal shown in portion (b) of FIG. 24 by the carrier signals of the sub-channels used during the write operation and shown in portion (c) of FIG. 24 and by integrated the products together within one symbol length, sub-channel data represented by these carrier signals can be read. In this case, the difference in frequency between the respective sub-channels of the read signal is the inverse number of the time representing one symbol length, i.e., a frequency corresponding to one symbol length. Consequently, only sub-channel data associated with the carrier signals can be read without interfering with each other.

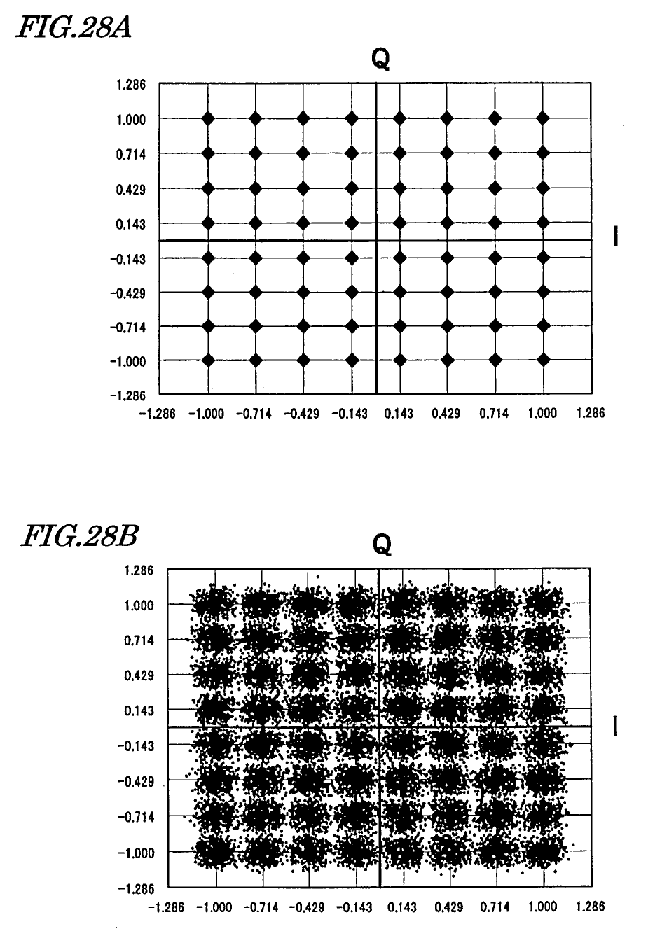

FIGS. 28A and 28B are signal arrangement diagrams plotted by multiplying the read signal shown in portion (b) of FIG. 24 by two carrier signals, of which the phases are different from each other by 180 degrees, integrating the products within one symbol length, and mapping the resultant two types of values to the axis of ordinates (Q-axis) and the axis of abscissas (I-axis), respectively. Specifically, FIG. 28A is a signal arrangement diagram in an ideal playback state with no noise at all, while FIG. 28B is a signal arrangement diagram in a situation where there is noise for a normal optical disk medium. The respective sub-channel signals have been subjected to the orthogonal amplitude modulation and the signal points are set on a sub-channel-by-sub-channel basis. Since the sub-channel signals have been modulated by the 64 QAM, there are 64 signal points. That is to say, one point represents six-bit data. Also, one point represents playback of one sub-channel. FIG. 28A shows an ideal playback state, and therefore, includes 64 dotted signal points. These signal positions will be reference signal positions. FIG. 28B is a signal arrangement diagram in a situation where noise has been superposed during the read operation. The read signal points have been expanded from the reference signal points shown in FIG. 28A as their centers. Approximately 32,000 signal points are presented over the entire diagram shown in FIG. 28B. Each of these read signal points can be converted into binary data by adopting the binary data value of a reference signal point that is closest to that signal point as the binary data value of that read signal point.

Portion (d) of FIG. 24 shows the read binary data. The six bits included in each pair of parentheses of this binary data represent the read data of one sub-channel and the read data of one symbol is included in the pair of braces. Since one symbol has nine sub-channels overall, 54 bits are read.

If this binary data is generated as a turbo code or a low-density parity code, for example, robust error correction is realized and the recording density can be further increased substantially.

Hereinafter, the reading and writing methods of this preferred embodiment of the present invention will be further described.

When the reading method shown in FIG. 24 is carried out, it is very important to find the top of a symbol on the waveform of a read signal. If the symbol top thus detected has deviated, then the deviation will present itself as a phase offset, thus causing a read error.

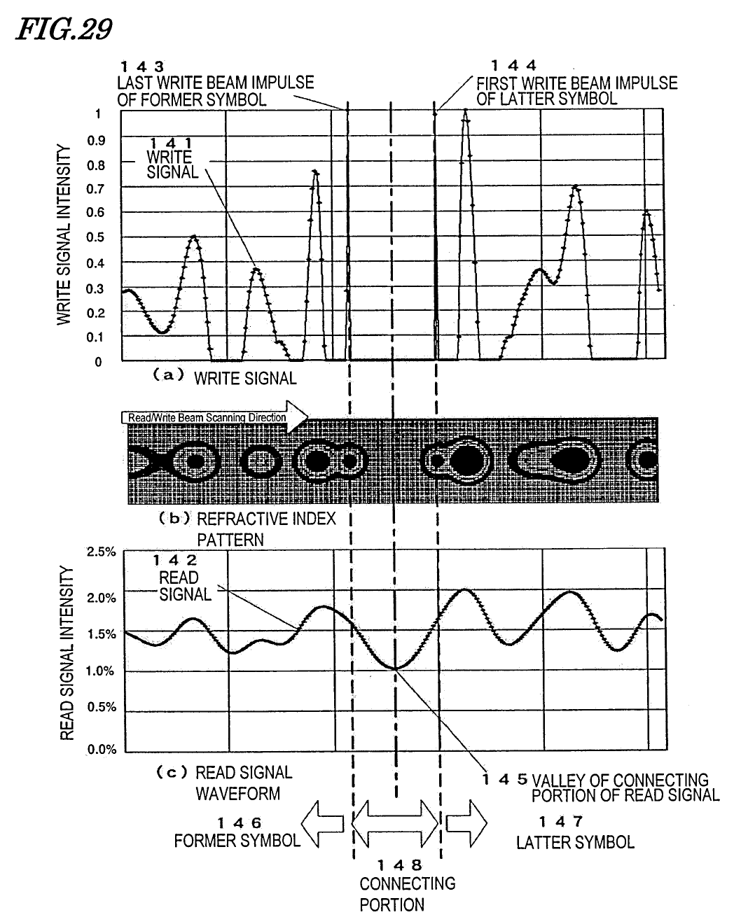

FIG. 29 shows a reading/writing method for detecting the top of a symbol. Specifically, portion (a) of FIG. 29 shows a write signal 141 that will produce a refractive index pattern to detect the top of a symbol. Portion (b) of FIG. 29 shows the resultant refractive index pattern when a write operation was performed using the write signal 141 shown in portion (a) of FIG. 29. And portion (c) of FIG. 29 shows a read signal 142 obtained by reading the refractive index pattern shown in portion (b) of FIG. 29. Portions (a), (b) and (c) of FIG. 29 show a symbol and portions located before and after the symbol connecting points with their on-track locations aligned with each other. On the left-hand side of FIG. 29, shown is the tail portion of the former symbol 146. In the middle of FIG. 29, shown is a symbol-to-symbol connecting portion 148. And on the right-hand side of FIG. 29, shown is the head portion of the latter symbol 147 to be connected to the end of the former symbol 146 on the left-hand side. In the connecting portion 148, the write signal 141 (shown in portion (a) of FIG. 29) has a power of zero. That is to say, the connecting portion 148 is a non-recorded portion, of which the length needs to be equal to or greater than the diameter of a read beam spot. By scanning the refractive index pattern shown in portion (b) of FIG. 29 with a read beam, the read signal 142 is obtained. As can be seen from portion (c) of FIG. 29, the center of the connecting portion 148 is aligned with the valley 145 of the connecting portion of the read signal. If the connecting portion 148 between the former and latter symbols 146 and 147 is a non-recorded portion, then the last write beam impulse 143 of the former symbol and the first write beam impulse 144 of the latter symbol have substantially the maximum value. The reason is as follows. Specifically, when the end portions of symbols are read using a refractive index pattern including a non-recorded portion between the symbols, a half of the read beam spot is formed in the non-recorded portion, and therefore, the read signal tends to have very small amplitude. That is why to maintain the amplitude of the read signal sufficiently high even at those end portions of the symbols, the power of the write beam impulses should be almost maximized. For that reason, the read signal in the symbol connecting portion 148 is symmetrical with respect to its centerline and the valley of the read signal is located on the centerline of the connecting portion 148. Since the head of the latter symbol 147 or the tail of the former symbol 146 is fixed with respect to the center of the connecting portion 148, the head of the latter symbol 147 or the tail of the former symbol 146 can be located by making calculations with respect to the center of the connecting portion 148. The write compensation section 95 (see FIG. 7) generates a write signal such that there is a non-recorded area of a predetermined length between the symbols as described above. Also, the write compensation section 95 generates a write signal such that the non-recorded area is located between areas irradiated with pulsed beams with almost the maximum power.

Optionally, a write signal, which has been subjected to write compensation with the powers of the last write beam impulse 143 of the former symbol and the first write beam impulse 144 of the latter symbol maximized from the beginning, may be generated to perform a write operation.

As described above, an area of a recording layer between two symbols includes a non-recorded area where no information is stored. The non-recorded area is interposed between two areas with a predetermined optical constant pattern. The demodulating section 104 locates the top of a symbol by reference to a signal component of a read signal representing the non-recorded area. Also, the demodulating section 104 generates a clock signal based on the signal representing the non-recorded area.

Hereinafter, it will be described in further detail how the optical disk drive 100 (see FIG. 7) performs a read operation.

The demodulating section 104 includes a read circuit 128, an orthogonal frequency division demodulator 131, and a turbo code demodulator 133. During reading, the pulse laser driver 110 controls the pulse laser diode 112 such that the laser diode 112 has continuous and constant optical power. However, its power is much smaller than the laser power for writing. The laser beam emitted from the pulse laser diode 112 is transformed into a parallel beam by the collimator lens 113, transmitted through the beam splitter 114 and the quarter-wave plate 115, and then incident on the objective lens 116.

The objective lens 116 is controlled by the objective lens actuator 117 so as to focus the laser beam on the recording layer 119. Unlike writing, the laser beam that has been focused on the recording layer 119 is too weak to change the composition of the recording layer 119. The laser beam that has been reflected from the recording layer 119 is transmitted through the objective lens 116 and the quarter-wave plate 115, reflected by the beam splitter 114, and then condensed by the condenser lens 121 onto the group of photosensors 122. The group of photosensors 122 output not only a focus sensor error signal 123 and a tracking sensor error signal 124, but also an analog read signal 125 as a sum of these sensor signals. The focus sensor error signal 123 and the tracking sensor error signal 124 are input to the servo circuit 126, which outputs the actuator drive signal 127 to the objective lens actuator 117, thereby controlling the objective lens actuator such that the laser beam is focused on the recording layer and that the laser beam spot is located right on the target track.

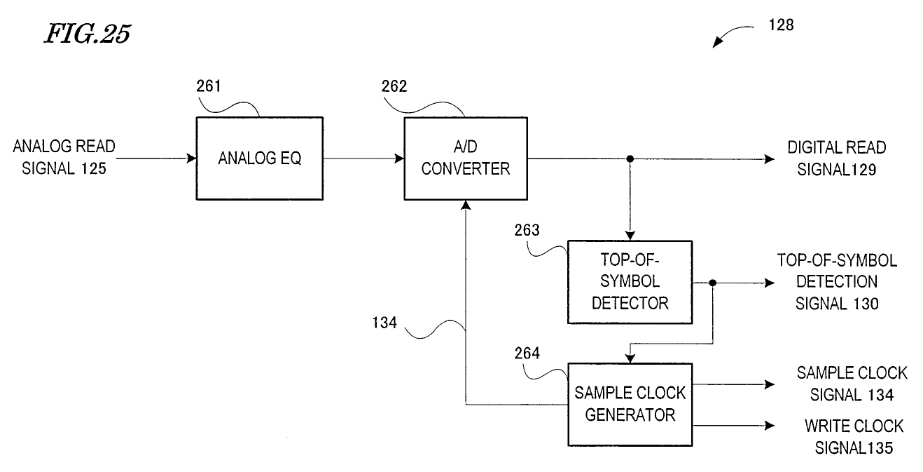

The analog read signal 125 is input to the read circuit 128. FIG. 25 shows the read circuit 128. The incoming analog read signal 125 is supplied to an analog EQ 261, where the signal has its low-frequency noise reduced and also has its high-frequency components boosted, and then input to an A/D converter 262. In response to a sample clock signal 134, the A/D converter 262 converts an analog value into a digital one, i.e., outputs a digital read signal 129. The digital read signal 129 is also input to a top of symbol detector 263, which detects a particular pattern that has been recorded at the top of each symbol, thereby outputting a top-of-symbol detection signal 130, which is supplied to a sample clock generator 264. The sample clock generator 264 outputs not only a sample clock signal 134, of which the phase is in sync with the timing of top-of-symbol detection, to the A/D converter and other circuits but also a write clock signal 135 to circuits on the writing section.

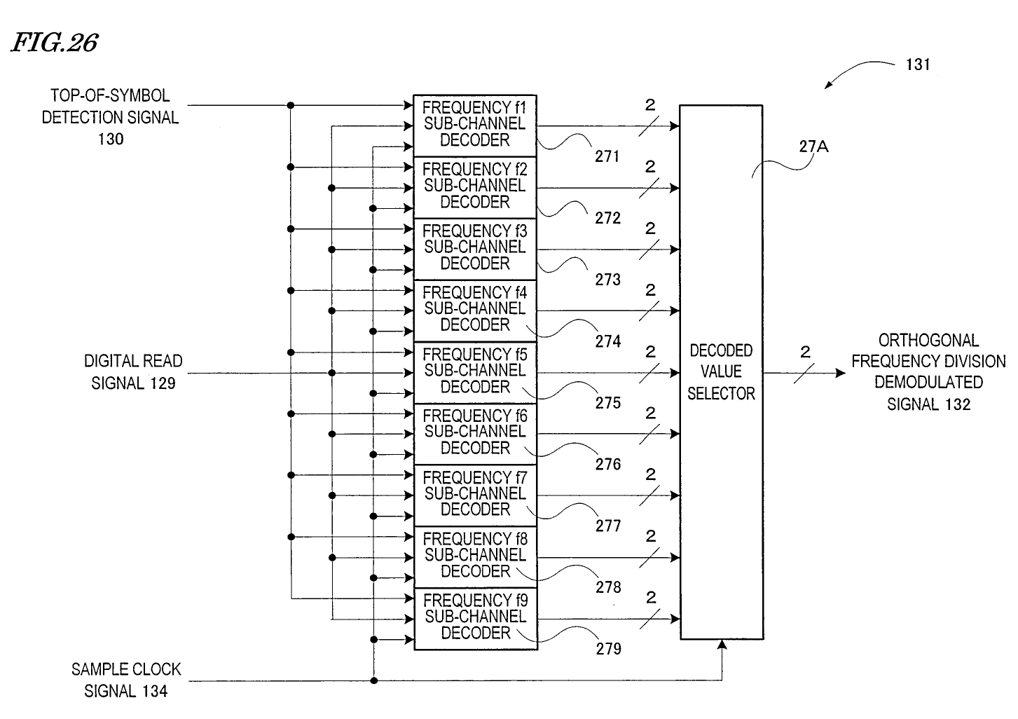

The digital read signal 129 that has been output from the read circuit 128 is supplied to the orthogonal frequency division demodulator 131. FIG. 26 shows the orthogonal frequency division demodulator 131.

The incoming digital read signal 129, along with the top-of-symbol detection signal 130 and the sample clock signal 134 (which is an operating clock signal for the orthogonal frequency division demodulator 131), is input to frequency f1 through f9 sub-channel decoders 271 through 279, each of which performs a Hilbert transform on a carrier with an associated one of the frequencies f1 through f9 by reference to the top-of-symbol detection signal 130, thereby carrying out the 64 QAM demodulation and outputting two signals with I and Q values. The sample clock frequency fp and the carrier frequency fsc (=one of f1 through f9) satisfy the following Equation (in which n=1 for f1 and n=9 for f9):

fsc=fp/(n×2^{m})

where is n is a natural number and n=1, 2, 3 . . . , or 9 and m is also a natural number.

The 64 QAM demodulated data I and Q values are output from the frequency f1 through f9 sub-channel decoders 271 through 279 to a decoded value selector 27A, which selectively and sequentially supplies the outputs of the frequency f1 through f9 sub-channel decoders 271 through 279. This output signal will be an orthogonal frequency division demodulated signal 132.

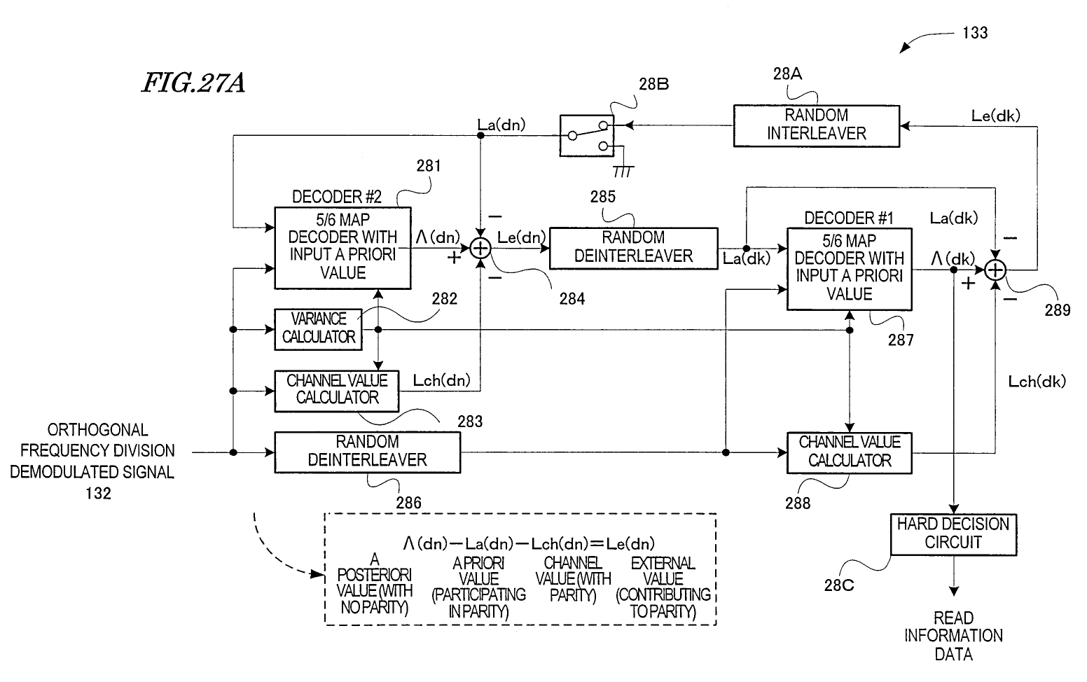

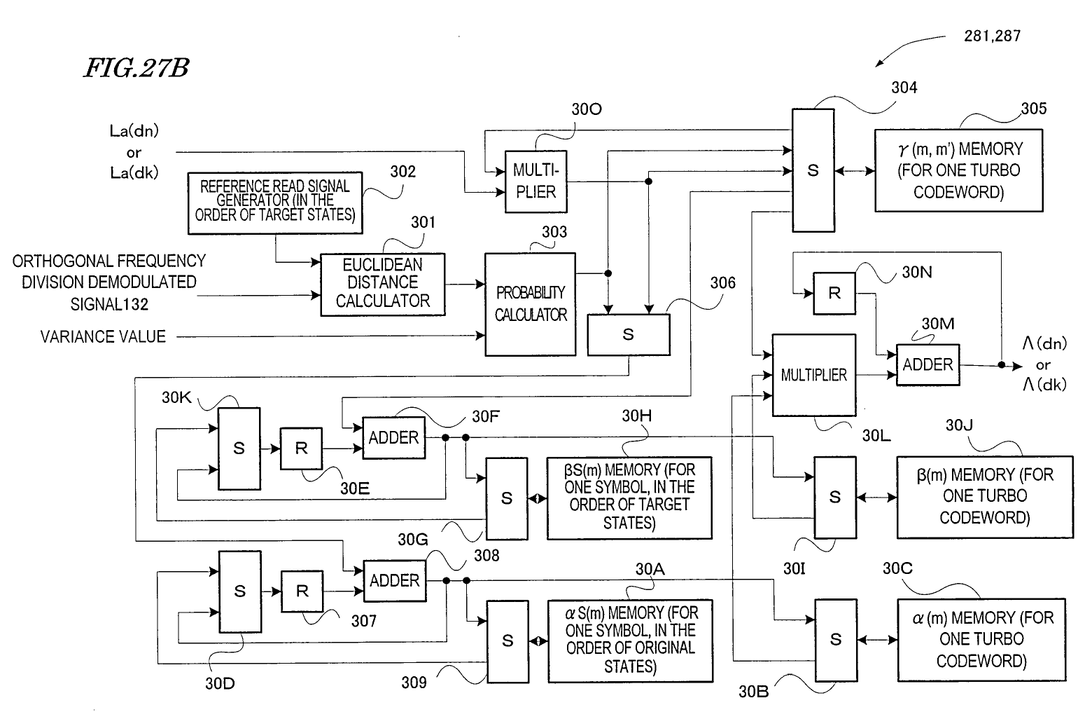

The orthogonal frequency division demodulated signal 132 is output from the orthogonal frequency division demodulator 131 to the turbo code demodulator 133. FIG. 27A shows the turbo code demodulator 133. Hereinafter, it will be described how the turbo code demodulator 133 operates.

The incoming orthogonal frequency division demodulated signal 132 is supplied to decoder #2 281, a channel value calculator 283, a variance value calculator 282, and a random deinterleaver 286.

The decoder #2 281 performs maximum a posteriori probability (MAP) decoding on the incoming series of orthogonal frequency division demodulated signal 132 corresponding to one turbo codeword, thereby outputting a posteriori probability on a data-by-data basis. In this case, the series of orthogonal frequency division demodulated signal 132 is input as a series coming from the ⅚ recursive systematic convolutional code modulator 224. That is why the parities are input in the order in which the data has been interleaved. In the following description, the order of this series will be identified by n and the data of this series by dn. In the same way, as for the series of data to which parities have been added from the series coming from the ⅚ recursive systematic convolutional code modulator 222, the order of the series will be identified by k and the data of the series by dk.

The variance value calculator 282 calculates a Euclidean distance from the incoming orthogonal frequency division demodulated signal 132 to its closest signal point, figures out a variance value, and outputs it to the decoder #2 281, the channel value calculator 283, decoder #1 287 and a channel value calculator 288. When decoding is performed for the first time, zero is input from the selector 28B as a priori probability for the decoder #2 281. That is to say, a priori probability becomes zero, which is not used for MAP decoding.

The channel value calculator 283 calculates, for each dn, a probability that the orthogonal frequency division demodulated signal 132 is the data dn. In this case, the orthogonal frequency division demodulated signal 132 is supposed to have a Gaussian distribution and is calculated based on the variance value supplied from the variance value calculator 282 and the Euclidean distance from the orthogonal frequency division demodulated signal 132 to each signal point.

The output ̂ (dn) of the decoder #2 281 and the output Lch(dn) of the channel value calculator 283 are subjected to the following calculation to derive an external value Le(dn):

̂(dn)−La(dn)−Lch(dn)=Le(dn)

When this calculation is done for the first time, a priori probability is zero. That is why La(dn)=0.

The external value calculated is deinterleaved by a random deinterleaver 285 and converted into the series of La(dk), which is used as a priori probability for the decoder #1 287 and is supplied to a priori probability input terminal of the decoder #1.

The series of deinterleaved orthogonal frequency division demodulated signal 132 that have been output from the random deinterleaver 286 at the same time are supplied to the decoder #1 287 and the channel value calculator 288.

The decoder #1 287 performs maximum a posteriori probability (MAP) decoding on the series of deinterleaved orthogonal frequency division demodulated signal 132, corresponding to one turbo codeword and supplied from the random deinterleaver 286, and a priori probability La(dk) supplied from the random deinterleaver 285, thereby outputting a posterior probability ̂(dk). In this case, the series of deinterleaved orthogonal frequency division demodulated signal 132 is input as a series coming from the ⅚ recursive systematic convolutional code modulator 222. That is why the parities are input in the order of the data.

The channel value calculator 288 calculates, for each dk, a probability that the orthogonal frequency division demodulated signal 132 is the data dk. In this case, the orthogonal frequency division demodulated signal 132 is supposed to have a Gaussian distribution and is calculated based on the variance value supplied from the variance value calculator 282 and the Euclidean distance from the deinterleaved orthogonal frequency division demodulated signal 132 to each signal point.

The output ̂(dk) of the decoder #1 287, the output Lch(dk) of the channel value calculator 288 and a priori probability La(dk) supplied from the random deinterleaver 285 are subjected to the following calculation to derive an external value Le(dk):

̂(dk)−La(dk)−Lch(dk)=Le(dk)

The external value calculated is interleaved again by a random interleaver 28A so as to be converted into the series of La(dn), which is used as a priori probability for the decoder #2 281 and is input to a priori probability input terminal of the decoder #2 281 by way of a selector 28B.

The decoder #2 281 calculates a posteriori probability ̂ (dn) again based on the incoming a priori probability La(dk) and the intermediate data (γ value) of previous MAP decoding, which is stored in the decoder #2 281. As in the previous time, the decoder #2 281 makes the following calculation to derive an external value Le(dk) and outputs it to the random deinterleaver 285 again.

̂(dn)−La(dn)−Lch(dn)=Le(dn)

It should be noted that La(dn) is the data that has been input to the decoder #2 281 and the channel value Lch(dn) is the same data as the previous time.

When the difference between La(dk) and its previous value becomes equal to or smaller than a predetermined value by performing decoding recursively a prescribed number of times, a hard decision circuit 28C outputs dk that has the highest a posteriori probability in the respective words received.

Next, it will be described in detail how the decoders #1 and #2 operate. FIG. 27B shows the decoders #1 and #2, which have the same configuration but are different in the order of data included in the incoming orthogonal frequency division demodulated signal 132, for example, i.e., whether the data has been interleaved (dn) or not (dk). Also, processing is carried out on a turbo codeword basis. Hereinafter, the operation to be performed when a new turbo codeword is input to the decoder #2 will be described.

(Step 11) The incoming orthogonal frequency division demodulated signal 132 is supplied to a Euclidean distance calculator 301, which calculates and outputs a Euclidean distance from the input orthogonal frequency division demodulated signal 132 to a reference read signal (i.e., a read signal with no errors), which has been generated by a reference read signal generator 302 in a predetermined order for every state produced as a result of the transition. In a ⅚ recursive systematic convolutional code, there are 32 states. Thus, 32×32=1,024 different Euclidean distances (i.e., all outputs shown in FIG. 20C) are calculated and output for a set of orthogonal frequency division demodulated signal 132.

The reference read signal generator 302 sequentially outputs signals rightward from F00 of the combination of the target state “00” and original state “00” shown in FIG. 20C. When the target state “00” is finished, the generator 302 starts outputting the signals by moving to the target state “10” on the lower table shown in FIG. 20C. In this manner, the reference read signal generator 302 alternately outputs the signals from the upper table and from the lower table on a row-by-row basis. And when the signals have been output through the end of the state “1f” on the lowermost row, the orthogonal frequency division demodulated signals for one symbol will have been output. When the next symbol is input, the signals are output in the same sequence all over again.

This turbo code is punctured alternately. The punctured portions are different parity bits of multiple codewords. That is why as for the punctured portion, the average of the probability when the parity bit is “0” and the probability when the parity bit is “1” is output as the probability described above. The upper table shown in FIG. 20C is associated with the parity bit “0”, while the lower table shown in FIG. 20C is associated with the parity bit “1”. For that reason, after the parity bits “0” and “1” of the upper and lower tables have been calculated and the average of the probability when the parity bit is “0” and the probability when the parity bit is “1” has been figured out for the punctured portion, the Euclidean distance calculator 301 outputs the Euclidean distance calculated.

(Step 12) The Euclidean distance thus obtained, supplied from the Euclidean distance calculator 301, is converted into a probability value based on the variance value supplied from the variance value calculator 282 and the Euclidean distance and then output by regarding the orthogonal frequency division demodulated signal 132 as having a Gaussian distribution.

(Step 13) The orthogonal frequency division demodulated signal that has been converted into a probability value gets stored in a γ (m, m′) memory 305 by way of a selector 304. The γ (m, m′) memory 305 retains the probability of transition from respective states for one turbo codeword into all states.

(Step 14) The orthogonal frequency division demodulated signal that has been converted into a probability value is also input to an adder 308 by way of a selector 306.

The adder 308 adds together the probability value and the output of a register 307 and outputs the sum. The probability value that has been added is input to, and stored in, the register 307 by way of a selector 30D. Thus, the output value of the register 307 becomes equal to that of the previous adder. The register 307 is reset every time the probability value of the first orthogonal frequency division demodulated signal of a turbo codeword to a symbol has been input and the target states are changed. That is why the sum of the probability values that have been input for the respective target states is output. The sum of the probability values for the respective target states is output from the adder 308, passed through selectors 309 and 30B, and then stored in an αS(m) memory 30A and an α(m) memory 30C, respectively. The αS(m) memory 30A stores the sum of the probabilities of transition from respective states of the orthogonal frequency division demodulated signal for one symbol into a single state. The α(m) memory 30C stores the sum of the probabilities of transition from respective states of the orthogonal frequency division demodulated signal for one symbol into a single state.

If the probabilities of the second or posterior orthogonal frequency division demodulated signal of a turbo codeword to a symbol are input, the values that have been stored in the order of transition in the register 307 by way of the αS(m) memory 30A and selector 30D are reset every time the target states are changed. Then, these values are used as initial values and added again by the adder, thereby updating the sum of the respective target state probability values.

(Step 15) When these processing steps are performed for one turbo codeword, the sum of the transition probabilities from the top of the turbo codeword through the state of each dn are stored in the α(m) memory. On the other hand, all transition probabilities within a single turbo codeword are stored in the γ(m, m′) memory 305.

(Step 16) The data stored in the γ(m, m′) memory 305 is read out reversely to the order of input of the orthogonal frequency division demodulated signals 132 and sequentially on a transition-by-transition basis. Specifically, in FIG. 20C, the transition probabilities are read downward from the probability associated with the F00 output of the original state “00” through that associated with the target state “0f”. Next, the transition probabilities of the original state “01” are read and output from the probability associated with the F01 output of the target state “10” through that associated with the target state “1f”. Thereafter, the transition probabilities of the original state “02” are output in the same way.

(Step 17) The outputs of the γ(m, m′) memory 305 are supplied to an adder 30F by way of the selector 304. As in the αS(m) memory, the symbol of the orthogonal frequency division demodulated signal input to the adder 30F for the first time is added by resetting the value of the register 30E to zero every time the original states are changed. As for the second symbol to be added and symbols that follow it, the sum for each original state stored in the βS(m) memory is loaded into the register 30E and used as the initial value for addition every time the original states are changed.

(Step 18) When these processing steps are performed for one turbo codeword, the sum of the transition probabilities from the top of the turbo codeword through the state of each dn are stored in the β(m) memory.

(Step 19) For all combinations of transitions m→m′ for the zeroth symbol d0=0, the sum of the products α(m)×γ (m, m′)×β(m) is calculated. The sum of the probabilities for d0=0 is input from the α(m) memory 30C to the multiplier 30L by way of the selector 30B. The transition probabilities for d0=0 are input from the γ(m, m′) memory 305 to the multiplier 30L. And the sum of the probabilities for d0=0 is input from the β(m) memory 30J to the multiplier 30L. In response, the multiplier 30L multiplies together these input values. And the product and the value stored in a register 30N are added together by an adder 30M. The value of the register 30N is retained until the input to the multiplier 30L is changed from dn=0 and is reset when dn=1. That is why the output value of the adder 30M becomes the sum of the values that have been added while dn=0.

(Step 20) The processing step 19 is performed on each symbol from dn=0 through dn=31 (i.e., for one turbo codeword).

Next, it will be described what if the orthogonal frequency division demodulated signal is input to the decoder #1 or what if a turbo codeword is input to the decoder #2 from the second round on. Hereinafter, it will be described how the decoder #2 operates. The decoders #1 and #2 have the same configuration but are different in the order of data included in the incoming orthogonal frequency division demodulated signal 132, for example, i.e., whether the data has been interleaved (dn) or not (dk).

(Step 21) A priori value La(dn) is input to the multiplier 30O. At the same time, a transition probability for dn is input from the γ(m, m′) memory 305 to the multiplier 30O by way of the selector 304. There are 32×32=1,024 transition probabilities (i.e., all shown in FIG. 20C) for dn. And all of those probabilities and a priori value La(dn) are multiplied together by the multiplier 30O and the products are output. The transition probabilities are read from the γ(m, m′) memory 305 in the same order as that of the reference read signal generated by the reference read signal generator 302. That is to say, the transition probabilities are sequentially output rightward from F00 of the combination of the target state “00” and original state “00” shown in FIG. 20C. When the target state “00”, is finished, the transition probabilities start to be output by moving to the target state “01”. And when the probabilities have been output through the end of the state “1f” on the lowermost row, the orthogonal frequency division demodulated signals for one symbol will have been output. When the next symbol is input, the signals are output in the same sequence all over again.

(Step 22) The product calculated by the multiplier 30O gets stored in the γ(m, m′) memory 305 by way of the selector 304. In the γ(m, m′) memory 305, the probability of transition from each of the states for one turbo codeword into every state is updated. After that, the same operation as that of step 14 is carried out.

In the foregoing description, every data is supposed to be floating point data. However, as long as the error can be estimated, calculations may also be done on fixed point data as well.

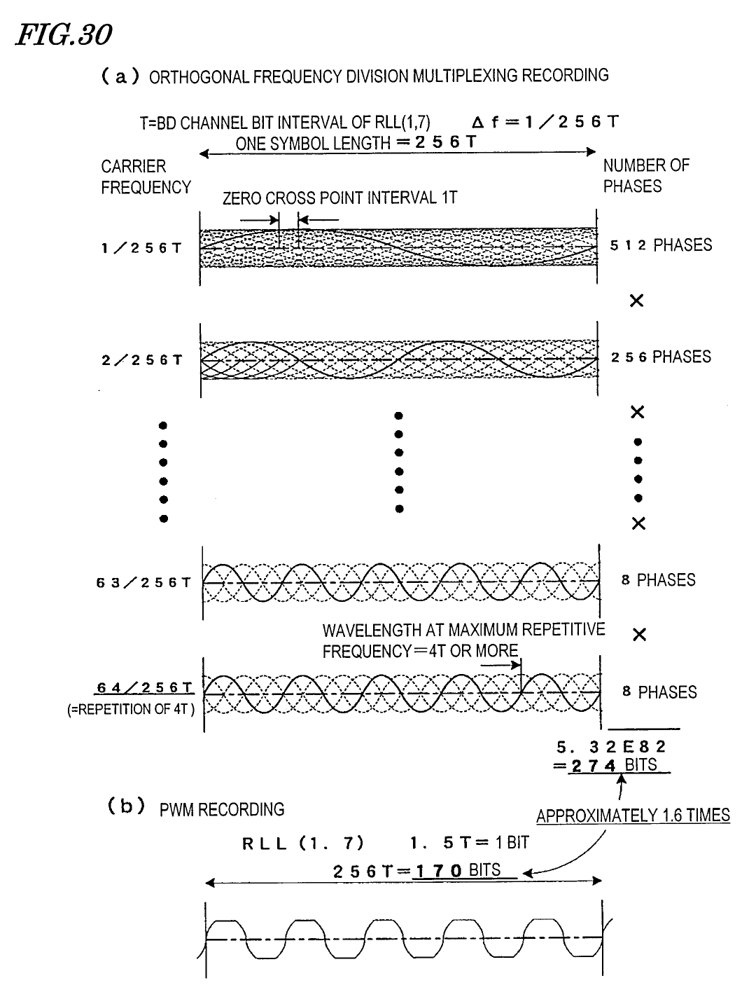

Next, the recording density achieved by the writing method of the present invention and that of the PWM recording, which is a conventional writing method, will be compared to each other with reference to FIG. 30. Portion (a) of FIG. 30 shows the estimated recording density achievable by the writing method of the present invention. It is estimated how much data can be stored with one channel bit for a BD supposed to be T and one symbol length supposed to be 256 T. Phase modulation is adopted as a method of modulation. The highest carrier frequency is supposed to be equal to the highest iterative frequency (of ¼ T) for a BD. And the phase interval of the phase modulation is supposed to be equal to the detection interval of 1 T for a BD. Also, since the symbol length is 256 T, the carrier frequency intervals between the respective sub-channels are supposed to be 1/256 T, i.e., the inverse number of the symbol length.

The uppermost graph of portion (a) of FIG. 30 shows the number of phases that a sub-channel with the lowest carrier frequency can have. The phases are detected where the sub-channel signal has zero amplitude, i.e., at so-called zero-cross points. The wavelength of this carrier is 256 T. Thus, there can be 256 zero-cross points for one wavelength. A single zero-cross point may be crossed by a sub-channel signal either downward or upward, thus causing two phases. Consequently, this sub-channel can have 512 phases. In the same way, a sub-channel with the second lowest carrier frequency has 256 phases. After that, 64 sub-channels can be superposed one upon the other up to a carrier frequency of T. These phases become the product of the numbers of phases of the respective sub-channels. Thus, the total number of phases for one entire symbol is 5.32×10⁸², which corresponds to information of 274 bits.

In portion (b) of FIG. 30, the number of bits that can be stored in 256 T by the PWM recording, which is a conventional writing method, is calculated. Supposing a write operation is performed by the RLL (1, 7) method, one bit is stored for 1.5 T, and therefore, 170 bits of information can be stored for 256 T.

As described above, 274 bits can be stored for 256 T according to the writing method of the present invention, whereas only 170 bits can be stored according to the conventional PWM recording method. Consequently, the recording density achieved by the writing method of the present invention can be approximately 1.6 times as high as that achieved by the conventional method.

In the two-photon absorption recording, the variation in the optical constant of the recording material is a quadratic function of the intensity of a write beam, and therefore, the recording pattern can be controlled three-dimensionally. That is why if this method is applied to three-dimensional recording on an optical disk medium with multiple recording layers, for example, the recording density can be further increased.

It should be noted that the operation performed by the optical disk drive 100 described above could be realized by means of software at least partially. For example, the optical disk drive 100 may include a memory device to store a program for performing the operations of the respective components described above and a central processing unit (CPU) that reads and executes the program. The optical disk drive 100 performs the operation described above following the program. The program may be either stored in advance in the memory device or downloaded and installed, for example.

### INDUSTRIAL APPLICABILITY

The present invention is particularly effectively applicable for use in the field of reading and writing information from/on information storage media.

1. An apparatus comprising
a write compensation section, which generates a write signal to write information on an information storage medium, and
a writing section for irradiating the information storage medium with a pulsed beam based on the write signal generated by the write compensation section,
wherein the information storage medium includes a recording layer, which has an optical constant that changes continuously with the total quantity of light received, and
wherein the writing section radiates and condenses multiple pulsed beams on the recording layer at an interval that is shorter than the diameter of the pulsed beams on the recording layer, and
wherein the write compensation section generates the write signal such that the each sum of variations in the optical constant at each irradiated spot of the pulsed beam on the recording layer through the end of a write operation forms a predetermined variation pattern.

2. The apparatus of claim 1, wherein the optical constant is a refractive index.

3. The apparatus of claim 2, wherein the refractive index varies in response to a two-photon absorption reaction of the material of the recording layer, and
wherein the probability of the two-photon absorption reaction is proportional to the square of the intensity of the pulsed beam.

4. The apparatus of claim 2, wherein the refractive index varies as the molecules of the recording layer change their directions perpendicularly to the plane of polarization of the pulsed beam, and
wherein the probability of change of the directions of the molecules is proportional to the square of the intensity of the pulsed beam.

5. The apparatus of claim 2, wherein the refractive index varies in response to a one-photon absorption reaction of the material of the recording layer, and
wherein the probability of the one-photon absorption reaction is proportional to the intensity of the pulsed beam.

6. The apparatus of claim 2, wherein the refractive index varies as the molecules of the recording layer change their directions perpendicularly to the plane of polarization of the pulsed beam, and
wherein the probability of change of the directions of the molecules is proportional to the intensity of the pulsed beam.

7. The apparatus of claim 3, wherein the material is diarylethene.

8. The apparatus of claim 4, wherein the recording layer includes photoaddressable polymers (PAPs).

9. The apparatus of claim 1, further comprising a modulating section for generating a signal representing the information by combining a plurality of sub-channel signals with each other,
wherein the information is written on the basis of a symbol with a predetermined length, and
wherein a difference in frequency between carrier signals of the sub-channel signals is an integral multiple of the product of the spatial frequency of the symbol and a relative velocity of a beam spot with respect to the information storage medium.

10. The apparatus of claim 9, wherein the sub-channel signals have been subjected to phase modulation and the number of phase divisions is defined for each said sub-channel.

11. The apparatus of claim 9, wherein the sub-channel signals have been subjected to orthogonal amplitude modulation and a signal point is set for each said sub-channel.

12. The apparatus of claim 9, wherein the write compensation section generates the write signal such that there is a non-recorded area with a predetermined length between the symbols.

13. The apparatus of claim 12, wherein the write compensation section generates the write signal such that the non-recorded area is located between areas irradiated with a pulsed beam with prescribed power.

14. The apparatus of claim 1, wherein the information storage medium comprises a plurality of recording layers including the recording layer.

15. An apparatus for generating a write signal to write information on an optical disk medium in the cast of use in an optical disk drive for writing data on the optical disk medium,
wherein the optical disk drive includes a writing section for irradiating the optical disk medium with a pulsed beam based on the write signal,
wherein the optical disk medium includes a recording layer, which has an optical constant that changes continuously with the total quantity of light received, and
wherein the writing section radiates and condenses multiple pulsed beams on the recording layer at an interval that is shorter than the diameter of the pulsed beams on the recording layer, and
wherein the apparatus generates the write signal such that the each sum of variations in the optical constant at each irradiated spot of the pulsed beam on the recording layer through the end of a write operation forms a predetermined variation pattern.

16. A writing method comprising the steps of:
generating a modulation signal to write encoded information on an information storage medium; and
irradiating the information storage medium with a pulsed beam based on the write signal,
wherein the information storage medium includes a recording layer, which has an optical constant that changes continuously with the total quantity of light received, and
wherein the step of irradiating includes radiating and condensing multiple pulsed beams on the recording layer at an interval that is shorter than the diameter of the pulsed beams on the recording layer, and
wherein the step of generating the write signal includes generating the write signal such that the each sum of variations in the optical constant at each irradiated spot of the pulsed beam on the recording layer through the end of a write operation forms a predetermined variation pattern.

17. A program set up to make an apparatus for writing data on an information storage medium perform recording processing,
wherein the recording processing includes the steps of:
generating a modulation signal to write information on the information storage medium; and
irradiating the information storage medium with a pulsed beam based on the write signal,
wherein the information storage medium includes a recording layer, which has an optical constant that changes continuously with the total quantity of light received, and
wherein the step of irradiating includes radiating and condensing multiple pulsed beams on the recording layer at an interval that is shorter than the diameter of the pulsed beams on the recording layer, and
wherein the step of generating the write signal includes generating the write signal such that the each sum of variations in the optical constant at each irradiated spot of the pulsed beam on the recording layer through the end of the recording processing forms a predetermined variation pattern.

18. An apparatus for reading information from an information storage medium,
wherein the information storage medium includes a recording layer, which has an optical constant that changes continuously with the total quantity of light received, and
wherein the information has been stored on the recording layer as a combination of a plurality of sub-channel signals, and
wherein the apparatus comprises:
a reading section, which irradiates the recording layer with a beam to generate a read signal based on the light that has been reflected from the information storage medium; and
a demodulating section, which multiplies the read signal and each of carrier signals together to generate each of sub-channel signals, associated with the respective carrier signal, and detect the information based on the sub-channel signals.

19. The apparatus of claim 18, wherein the information has been stored on the recording layer on the basis of a symbol with a predetermined length, and
wherein there is a non-recorded area that stores no information between the symbols of the recording layer, and
wherein the demodulating section detects the top of the symbol by reference to a signal indicating the non-recorded area in the read signal.

20. The apparatus of claim 19, wherein the demodulating section generates a clock signal based on the signal indicating the non-recorded area.

21. The apparatus of claim 19, wherein the non-recorded area is interposed between areas with a predetermined optical constant pattern.

22. An information storage medium comprising a base material and a recording layer for storing information,
wherein the information is stored in the recording layer on the basis of a symbol with a predetermined length, and
wherein there is a non-recorded area that stores no information between the symbols of the recording layer.

23. The information storage medium of claim 22, wherein the recording layer has an optical constant that changes continuously with the total quantity of light received, and wherein the non-recorded area is interposed between areas with a predetermined optical constant pattern.

24. The apparatus of claim 5, wherein the material is diarylethene.

25. The apparatus of claim 6, wherein the recording layer includes photoaddressable polymers (PAPs).
